(19) United States
(12) Patent Application Publication
(10) Pub. No.: US 2019/0210221 A1
(43) Pub. Date: Jul. 11, 2019

(54) ROBOTIC ITEM RETRIEVAL AND DISTRIBUTION SYSTEM

(71) Applicant: AVAR ROBOTICS INC., Brooklyn, NY (US)

(72) Inventor: Stephen Delaporte, Brooklyn, NY (US)

(21) Appl. No.: 16/236,475

(22) Filed: Dec. 29, 2018

Related U.S. Application Data
(60) Provisional application No. 62/612,241, filed on Dec. 29, 2017.

(51) Int. Cl. B25J 9/16

(52) U.S. Cl. CPC B25J 9/1612; B25J 9/162; B25J 9/1682

(57) ABSTRACT

A robotic storage and retrieval system with mobile robotic vehicles having local manipulators and storage platforms is provided. The robotic storage and retrieval system also utilizes carrier cartridges which are dedicated to each individual item within a complete distribution environment. Each carrier cartridge may include a universal interface to ensure that a gripper can easily grab and move each item with the same level of accuracy every time. An RFID tag may also be included with each carrier cartridge to provide a method for absolute tracking of all items. Elevators and other kinds of carrier mobile robots may also be integrated with the entire automated storage and retrieval system.

### CROSS REFERENCE TO RELATED APPLICATIONS

This application claims the benefit of U.S. Provisional Patent Application No. 62/612,241, filed on Dec. 29, 2017, which is incorporated in its entirety herein by reference.

### FIELD OF TECHNOLOGY

The technology of the present disclosure relates to automated retrieval systems, and some particular embodiments relate to an automated retrieval system that can store, retrieve, sort, and distribute individual or multiple inventory items and packages.

### BACKGROUND OF THE INVENTION

Automated storage and retrieval systems have a long history of integrating many different kinds of technologies. Solutions for moving material within different environments often include either a robotic arm component, a manipulator, or a mobile robotic platform. Sometimes these elements are integrated together, but more often than not, these elements are utilized in such a way that they perform functions separate from each other. Solutions may also integrate mobile robots that don't include robotic arms or manipulators, or robotic arms and manipulators that only operate in conjunction with conveyor belts rather than with mobile robots.

Many of these solutions may still be very limiting in terms of the accuracy and speed with which they are able to retrieve and distribute items within environments that include a large variety of goods and material having various kinds of weights, sizes, and geometries. The cost of such solutions may also be improved upon by standardizing the physical interface with which each item is grabbed and moved by, and through the methods by which each item is tracked.

The implementation of computer vision is often used at present to detect the orientation and identity of an item so that it may be picked from a larger group of items by a robotic manipulator. While this provides a viable solution, it is still not one hundred percent accurate, especially as it relates to providing the information needed for a gripper to grab an item and then place it accurately. Releasing items so that they are dropped into a bin without exact placement precision is instead the case with most solutions that use computer vision for the manipulation of material today.

### BRIEF SUMMARY OF THE DISCLOSURE

To overcome the limitations that the current solutions provide at present, physical standardization, mechanical predictability, and accurate tracking are major components that can be leveraged to provide a more precise and efficient solution for material handling within large scale distribution environments. There is a need for a robotic storage and retrieval system that can achieve greater accuracy through the use of carrier cartridges that are provided for each individual item. Each carrier cartridge may include a universal interface to ensure that a gripper can easily grab and move each item in the same way every time to reduce complexity and improve accuracy. A radio-frequency identification (RFID) tag may also be included with each carrier cartridge to provide a method for absolute tracking of all items.

Many of these solutions may still be very limiting in terms of the accuracy and speed with which they are able to retrieve and distribute items within environments that include a large variety of goods and material having various kinds of weights, sizes, and geometries. The cost of such solutions may also be improved upon by standardizing the physical interface with which each item is grabbed and moved by, and through the methods by which each item is tracked.

A robotic vehicle with a local manipulator is also provided to allow items to be picked from gravity feed shelves. A local storage platform may be included with each robotic vehicle. Elevators and other kinds of carrier mobile robots may also be integrated with the entire automated storage and retrieval system.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a view of one embodiment of a robotic end effector and a carrier platform coupled to a base drive plate, in accordance with one or more embodiments of the present disclosure.

FIG. 2 is a partially exploded view of one embodiment of a robotic end effector and a carrier platform coupled to a base drive plate, in accordance with one or more embodiments of the present disclosure.

FIG. 3 is a fully exploded view of one embodiment of a robotic end effector and carrier platform coupled to a base drive plate, in accordance with one or more embodiments of the present disclosure.

FIG. 4 illustrates a top view of a motion sequence for the gripper portion of a robotic end effector, in accordance with one or more embodiments of the present disclosure.

FIG. 5 illustrates a top view of a motion sequence for a robotic end effector and a carrier plate grabbing and then ejecting an item, in accordance with one or more embodiments of the present disclosure.

FIG. 6 is a view of a robotic end effector and carrier plate shown detached from a drive plate and another embodiment of a robotics end effector and carrier plate shown detached from a drive plate, in accordance with one or more embodiments of the present disclosure.

FIG. 7 illustrates another lifting motion sequence for a robotic end effector and a carrier plate shown in FIG. 6, in accordance with one or more embodiments of the present disclosure.

FIG. 8 is a view of a robotic system and its supporting structure with the end effector shown in FIG. 1 integrated with a gantry and a belt drive to provide actuation along its long axis, and a second belt drive integrated to actuate the end effector along its short axis, in accordance with one or more embodiments of the present disclosure.

FIG. 9 is a view of a robotic system and its support structure with the end effector shown in FIG. 1 integrated with a gantry and wheels to provide actuation along its long axis, and a belt drive integrated to actuate the end effector along its short axis, in accordance with one or more embodiments of the present disclosure.

FIG. 10 is a view a robotic system and its supporting structure with the end effector shown in FIG. 1 integrated with a gantry, which is actuated by a first set of wheels along its long axis and a second set of wheels situated perpendicular to the first set of wheels to move the gantry perpendicularly, and a belt drive to actuate the end effector along the system's short axis, in accordance with one or more embodiments of the present disclosure.

FIG. 11 is a view of a robotic system which integrates the embodiments shown from FIG. 8 or 9 in a stacked configuration, in accordance with one or more embodiments of the present disclosure.

FIG. 12 illustrates a side view of a motion sequence of a robotic system and its end effector grabbing an item which has been deployed from a gravity chute with an integrated gate mechanism, in accordance with one or more embodiments of the present disclosure.

FIG. 13 illustrates a perspective view of the same motion sequence shown in FIG. 12 of a robotic system and its end effector grabbing an item, in accordance with one or more embodiments of the present disclosure.

FIG. 14 is a view of the robotics system shown in FIG. 11 having a first set of gravity chutes for item retrieval on each level and a second set of gravity chutes used for package distribution to conveyor belts situated below, in accordance with one or more embodiments of the present disclosure.

FIG. 15 is a view of the robotic system shown in FIG. 11 having a first set of gravity chutes for item retrieval and a set of mobile robots carrying bins to retrieve the items ejected from the end effectors above, in accordance with one or more embodiments of the present disclosure.

FIG. 16 is a view of the robotic system from FIG. 14 shown retrieving items from a truck unloading dock, in accordance with one or more embodiments of the present disclosure.

FIG. 17 is a view of three common store items contained within separate carrier cartridges, each of which include an embedded RFID sensor, a gripper interface on each side, and compression locks, in accordance with one or more embodiments of the present disclosure.

FIG. 18 is a diagram of a carrier cartridge containing a store item highlighting an example compression lock feature, in accordance with one or more embodiments of the present disclosure.

FIG. 19 is a sectional view diagram of a carrier cartridge and its underlying latch mechanism in an open and closed state, in accordance with one or more embodiments of the present disclosure.

FIG. 20 is a diagram of the end effector from FIG. 1 shown grabbing items contained within carrier cartridges from a gravity chute as an overhead RFID antenna reads the RFID sensors embedded within the end effector and each of the carrier cartridges below, in accordance with one or more embodiments of the present disclosure.

FIG. 21 is a diagram of the end effector from FIG. 1 shown grabbing an item held in a carrier cartridge, then two items held in two separate carrier cartridges, and then three items held in three separate carrier cartridges, all deployed from a gravity chute, in accordance with one or more embodiments of the present disclosure.

FIG. 22 is a sectional view diagram of the end effector from FIG. 1 shown grabbing and relocating a carrier cartridge, with an item held inside, from a gravity chute onto the end effector's carrier platform, in accordance with one or more embodiments of the present disclosure.

FIG. 23 is a diagram of a robotic system with the end effector from FIG. 1 shown in operation retrieving multiple jars of mayonnaise, each held within its own carrier cartridge, and then relocating those jars of mayonnaise from a gravity chute to a local gantry carrier platform, in accordance with one or more embodiments of the present disclosure.

FIG. 24 is a diagram of a robotic system with the end effector from FIG. 1 shown in operation retrieving an example gallon of milk, held within its own carrier cartridge, and then relocating that gallon of milk from a gravity chute to a local gantry carrier platform, in accordance with one or more embodiments of the present disclosure.

FIG. 25a is a diagram of a robotic system with the end effector from FIG. 1 shown in operation retrieving a loaf of bread, held within its own carrier cartridge, and then relocating that loaf of bread from a gravity chute to a local gantry carrier platform, in accordance with one or more embodiments of the present disclosure.

FIG. 25b is a sequence diagram of a robotic vehicle with an end effector that includes a gripper and a tilt plate shown in operation retrieving and distributing jars from a gravity chute to a local gantry carrier platform, in accordance with one or more embodiments of the present disclosure.

FIG. 25c is a continuation of FIG. 25b showing a sequence diagram of a robotic vehicle with an end effector that includes a gripper and a tilt plate shown in operation retrieving and distributing jars from a gravity chute to a local gantry carrier platform, in accordance with one or more embodiments of the present disclosure.

FIG. 25d is a view of the front side of the sequence diagram from FIG. 25b showing a robotic vehicle with an end effector that includes a gripper and a tilt plate shown in operation retrieving and distributing jars from a gravity chute to a local gantry carrier platform through a dynamic door opening on the back of a carrier cartridge, in accordance with one or more embodiments of the present disclosure.

FIG. 26 is a view of a robotic system similar to FIGS. 23, 24, and 25, shown in a stacked configuration with an elevator platform to lower items into a cart, in accordance with one or more embodiments of the present disclosure.

FIG. 27 is a diagram of the robotic system from FIG. 26 shown distributing items in carrier cartridges from the gantry carrier platform to an elevator carrier platform using gravity and a mechanical gate, in accordance with one or more embodiments of the present disclosure.

FIG. 28 is a diagram of the robotic system from FIG. 26 shown distributing items in carrier cartridges from an elevator carrier platform to a cart using gravity and a mechanical gate, in accordance with one or more embodiments of the present disclosure.

FIG. 29 is a view of a robotic system which combines an embodiment consistent with that shown in FIG. 10 with an embodiment consistent with that shown in FIG. 26 to illustrate an integrated system where items are distributed from one set of gantry robots to the gravity chutes, and then from there the items are retrieved and distributed from a second set of gantry robots to the elevator and cart, in accordance with one or more embodiments of the present disclosure.

FIG. 30 is a partial view of the robotic system embodiment shown in FIG. 29 configured as a fully automated store with multiple layers, an extended structure for greater travel, and a kiosk section for customer item selection and cart deployment, in accordance with one or more embodiments of the present disclosure.

FIG. 31 is a perspective view of the robotic system shown in FIG. 29 configured with two major blocks as a fully automated store with multiple layers, an extended structure for greater travel, and a kiosk section for customer item selection and cart deployment, in accordance with one or more embodiments of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements. It will further be appreciated that the figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION

In the following detailed description, numerous specific details are set forth in order to provide a thorough understanding of the disclosed technology. However, it will be understood by those skilled in the art that the presently disclosed technology may be practiced without these specific details. In other instances, well-known methods, procedures, and components have not been described in detail so as not to obscure the presently disclosed technology.

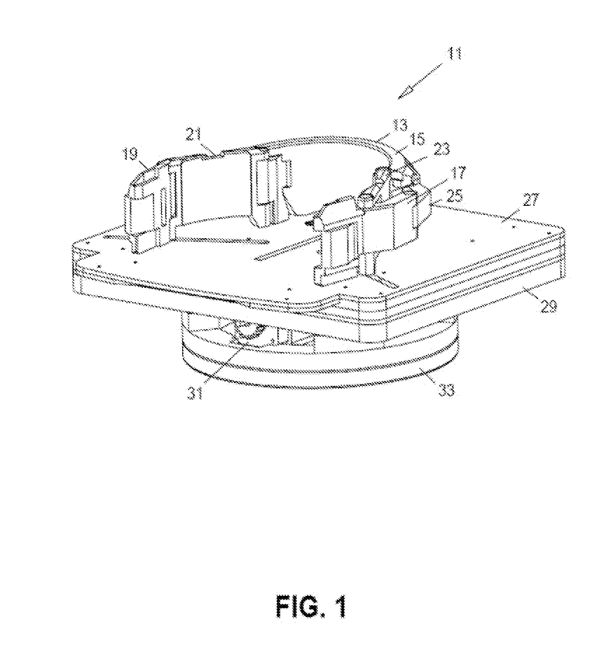

In accordance with the example embodiment shown in FIG. 1, robotic end effector 11 is shown with one or more core components including gripper 13, which may be situated above and coupled to carrier platform 27. Carrier platform 27 is further coupled to base drive plate 29 through either magnetic mechanisms or a variety of other mechanisms such that a locking action can be achieved to quickly couple and decouple end effector 11 or any other kind of end effector from its top surface. Motor 31 is situated within drive plate 29 to provide actuation that can be translated through carrier platform 27 to in turn provide motion to gripper 13. An intermediate layer of mechanics can be integrated within each end effector in different configurations to accommodate different mechanical outputs, whether it be to change torque output or the end effector's fundamental kinematic output. A core degree of freedom that allows end effector 11 to rotate centrally is enabled by a cylindrical structural support and thrust bearing 33. As shown, the gripper 13 may be made up of a four bar linkage with gripper ends 17 and 19 situated at the front of gripper 13 to directly manipulate items that are being grabbed, while links 25 and 18 (link 18 is shown in a later figure), and ejection panels 21 and 23 make up a four bar linkage to provide a robust and consistent mechanical output which is also coupled to diagonal guide tracks below that are situated at the top of carrier platform 27. Back support structure 15 from gripper 13 is also along on a guide track below at the top surface of carrier platform 27 such that it is directly attached to an internal drive mechanism and constrained to a linear motion. This linear motion provides the actuation needed to change the position of gripper ends 17 and 19.

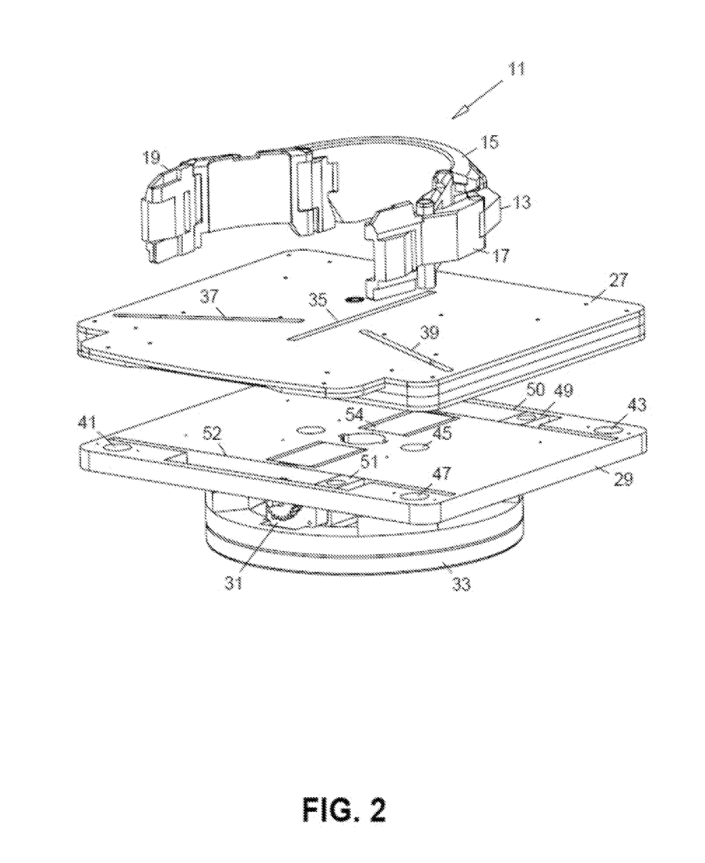

In accordance with the example embodiment shown in FIG. 2, robotic end effector 11 is shown again with its core components, but here it is illustrated in a partially exploded state to show how each major component may be interfaced with one another in one or more embodiments. Base drive plate 29 is shown decoupled from carrier platform 27 to highlight linear actuators 49 and 51, which slide along guide channels 50 and 52 respectively and are driven through a rack and pinion mechanism coupled to motors 54 and 31 respectively. It should be understood that while a set of two motors and two linear actuator outputs are shown, as many as six or more motors could also be configured embedded within base drive plate 29 with their outputs having similar or alternative kinds of drive mechanisms. Linear actuators 49 and 51 are shown with holes where a post from a matching linear drive mechanism from the underside of carrier plate 27 can become engaged when base drive plate 29 is coupled to carrier platform 27 to translate motion to end effector 11 and its corresponding gripper 13. Linear actuators 49 and 51 can also be coupled to their corresponding linear drive mechanisms from carrier platform 27 through magnets. Similarly, magnets 41, 45, 47, and 43 which are located at the center and along the edges of base drive plate 29 provide a magnetic force to pull and align corresponding magnets on the underside of carrier platform 27 as a locking mechanism to couple it with base drive plate 29, and this could also be achieved through other coupling and decoupling mechanical mechanisms. Gripper ends 17 and 19 are diagonally guided along guide tracks 39 and 37 respectively, which may be located at the top of carrier platform 27 and may be driven by the linear motion of back support structure 15 of gripper 13 which is guided along linear guide channel 35.

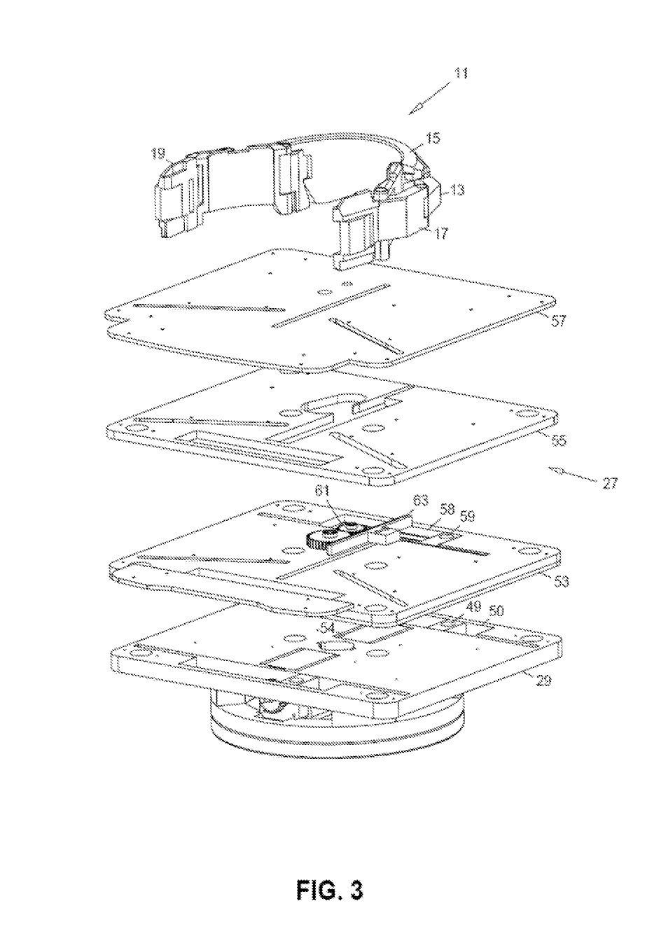

FIG. 3 similarly shows one or more core components of end effector 11, but in a fully exploded state to better illustrate further the internal drive mechanism details that may be implemented in accordance with one or more embodiments of the present disclosure. Motor 54 with an attached pinion embedded within base drive plate 29 drives the rack of linear actuator 49 along guide channel 50 which in turn actuates linear drive 59 situated within guide channel 58 in lower plate 53 of carrier platform 27. A rack attached with linear drive 59 may actuate gear drive 61 to translate motion perpendicularly to linear drive 59 through the final output with linear drive 63 which is also made up of a rack. Linear drive 63 may be coupled to back support structure 15 with connecting posts that slide through upper panel 57 of carrier platform 27 through linear guide channel 35 as also shown from FIG. 2.

The object of the aforementioned robotic end effector and drive design is to reduce the cost of the end effector by translating motion directly from motors that are built directly into the robotic system's base drive plate. This effectively allows each end effector added to the system to use the same motors, which dramatically reduces the overall cost as a typical end effector will have its own embedded motor, especially for one used with a robotic arm. It should be noted that a lifting and unlocking actuator and mechanism could also be added to base drive plate 29 to more easily allow the system to swap out different end effectors autonomously.

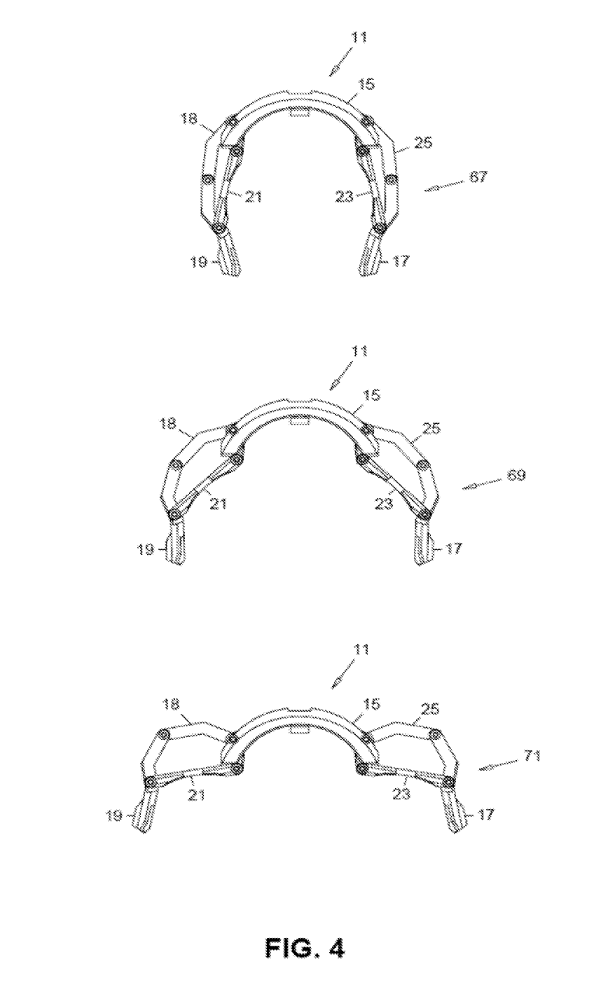

In accordance with the example embodiment shown in FIG. 4, gripper 13 is shown in three states and is mechanically constructed using a four bar linkage made up of links 18 and 25, ejection panels 21 and 23, and the links driving gripper ends 17 and 19. In the first state 67 gripper 13 is at rest. In the second state 69 gripper 13 is shown in a partially open state where gripper ends 17 and 19 are partially angled to allow an item to fit between them. In the third state 71 illustrated, gripper 13 is shown in a fully expanded state whereby gripper ends 17 and 19 are angled even further to allow a larger package to be grabbed when the full assembly is retracted back. As gripper 13 is partially expanded and then fully expanded, ejection panels also become angled to eject items that are grabbed by gripper 13. Variations on this gripper design could improve precision depending on the exact application, but the gripper design depicted allows for grabbing and ejecting to occur with a single linear motion, which simplifies the design and also further reduces cost for the entire end effector. Additional front panels can also be added to the sides of gripper ends 17 and 19 to allow the gripper to more easily adapt to angled items or items shaped differently from a rectilinear configuration. This gripper will however work best with rectilinear shaped items such as standard rectangular shaped packages.

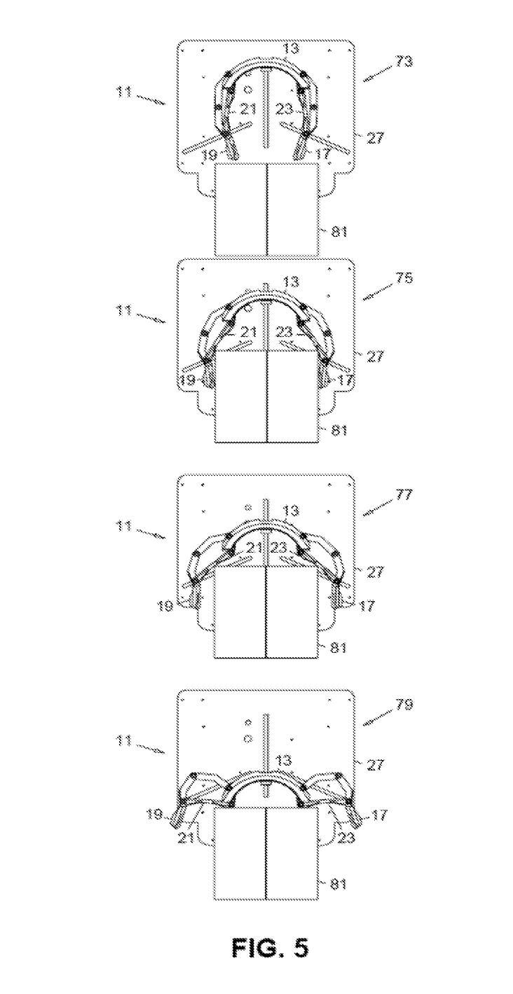

FIG. 5 highlights how gripper 13 is part of the full assembly of end effector 11 along with its underlying carrier platform 27 which can grab and then eject a rectangular shaped package while also carrying it. End effector 11 leverages gravity by allowing the item being grabbed to also be carried on carrier platform 27, whereas a typical robotic arm, or articulated robot, would need to use extra degrees of freedom and additional torque to lift an item. Extra force from the gripper would also need to be applied to the item being manipulated in a standard articulated robot or robotic arm configuration. Similar to FIG. 4, FIG. 5 shows gripper ends 17 and 19 of gripper 13 first grabbing package 81 in the second state 75, and then ejecting it with ejection panels 21 and 23 in the third state 77 and fourth state 79.

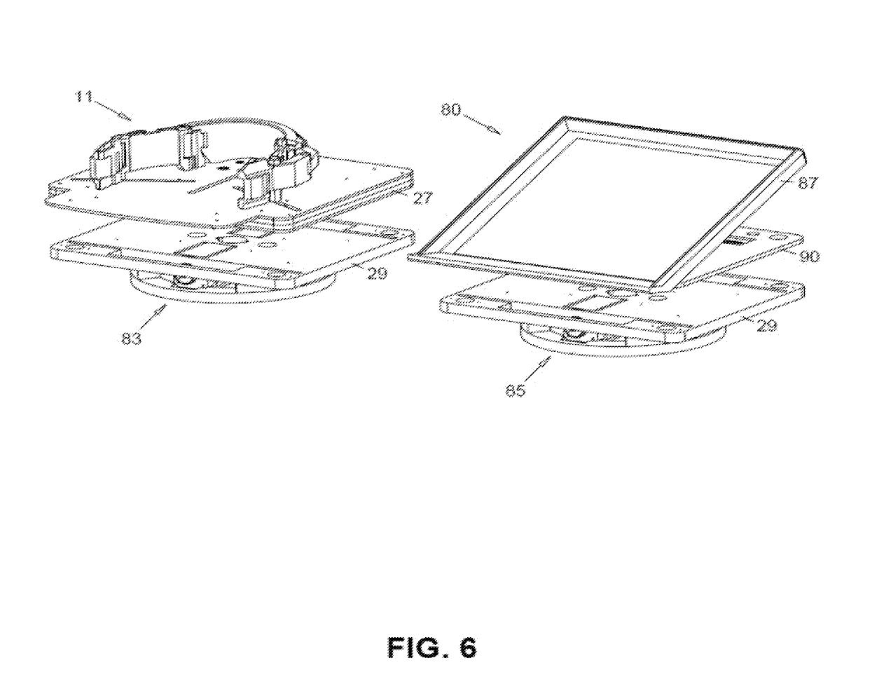

In accordance with the example embodiments shown in FIG. 6, a first embodiment 83 shows end effector 11, which is made up of gripper 13 and carrier plate 27, on the left side decoupled from base drive plate 29. Another embodiment 85 is shown to highlight how the same base drive plate 29 can be coupled to a separate end effector 80 which may be made up of an attachment platform 90 and a lifting plate 87 that allows items to be carried and then deployed using gravity.

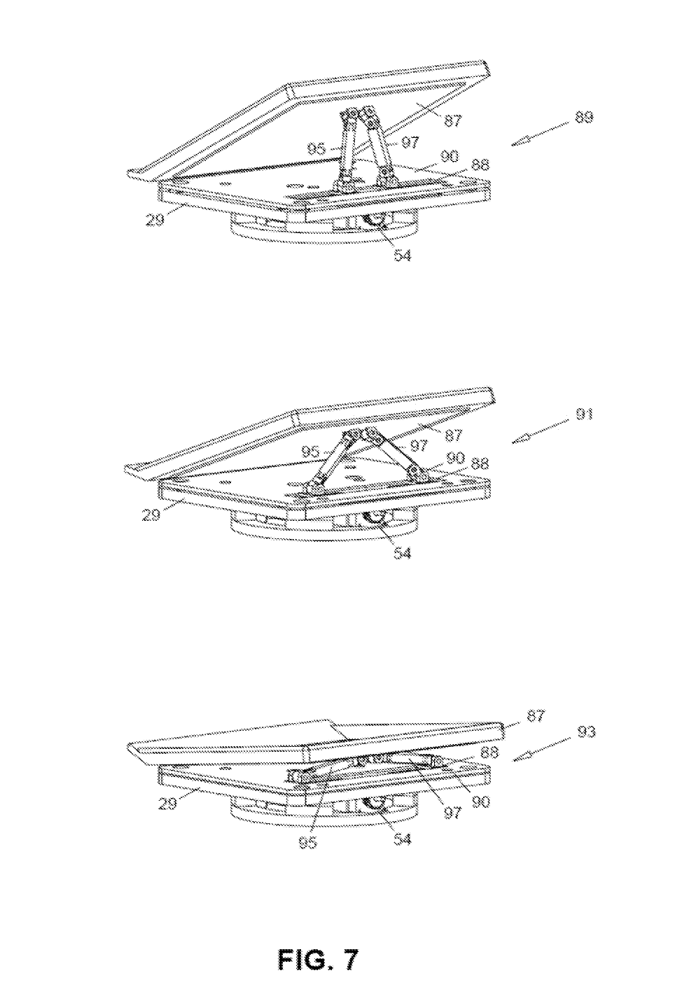

FIG. 7 elaborates on how end effector 80 shown in FIG. 6 works mechanically using the same drive mechanism to actuate end effector 11 shown in previous figures. Three states, 89, 91, and 93 are shown in a lifted, partially lifted, and flattened state respectively. Lifting members 95 and 97 are guided along channel 88 and may be actuated below by motor 54. The core internal mechanics for base drive plate 29 may be the same as shown in FIG. 3.

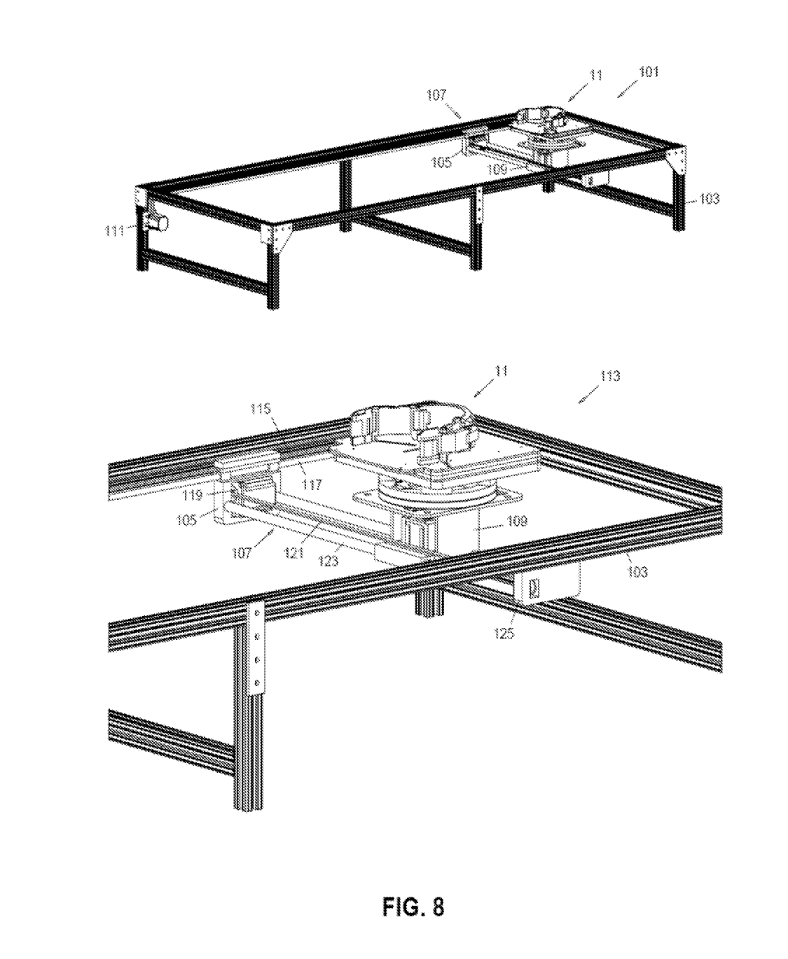

In accordance with the example embodiment shown in FIG. 8, robotic system 101 used for retrieval and distribution of items, and its support structure 103 is shown integrated with end effector 11 and gantry 107. Along the internal axis of gantry 107 sits the end effector drive unit 109 to which end effector 11 is coupled. A detail 113 of robotic system 101 shows the finer components to the assembly, which includes belt drive 121 driven by motor 119 and is situated along the internal axis of gantry 107 and the end effector drive unit 109 along guide track 123 and is affixed to gantry end support 105 which rides along guide track 117. Belt drive 115 provides actuation along the long axis of robotic system 101 and is driven by motor 111. An additional belt drive and guide track is also mechanically coupled to gantry end support 125 on the opposing side of robotic system 101 to provide an equal amount of force distribution.

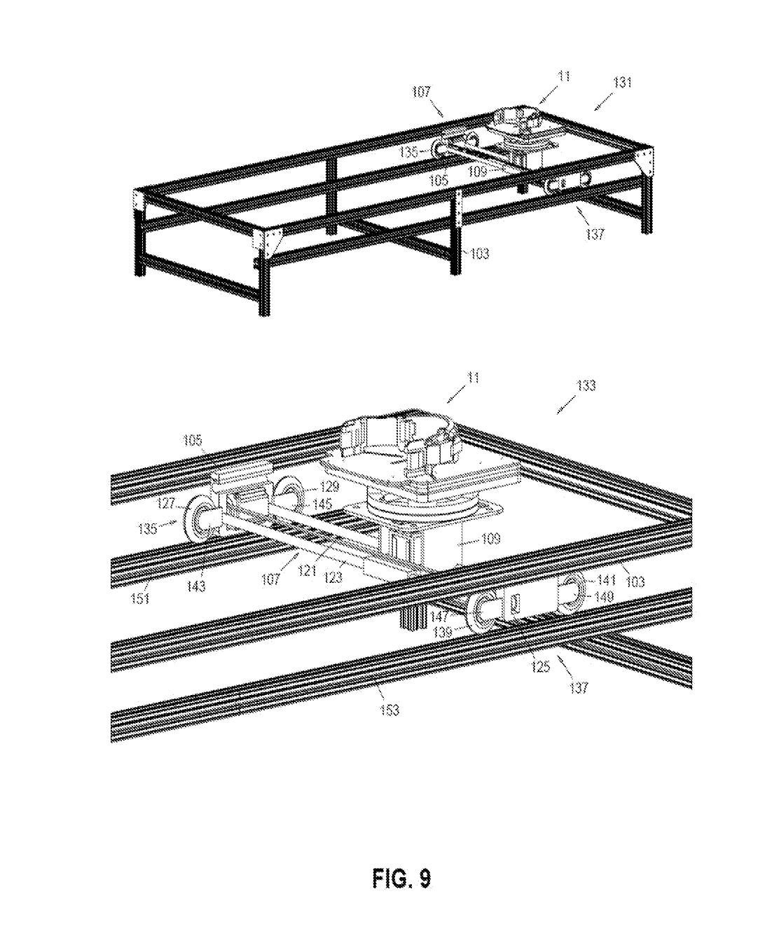

In accordance with the example embodiment shown in FIG. 9, similar to FIG. 8, robotic system 131 used for retrieval and distribution of items, and its support structure 103 is shown integrated with end effector 11 and gantry 107. Along the internal axis of gantry 107 sits the end effector drive unit 109 to which end effector 11 is coupled. A detail 133 of robotic system 131 shows the finer components to the assembly, which includes belt drive 121 driven by motor 119 and is situated along the internal axis of gantry 107 and drives end effector drive unit 109 along guide track 123 and is affixed to gantry end support 105 which rides along guide track 117. Wheel drive assembly 135 which is made up of motor drives 143 and 145 and wheels 127 and 129 provides actuation along the long axis of robotic system 101 and is driven along guide track 151. An additional wheel drive assembly 137 which is made up of motor drives 147 and 149 and wheels 139 and 141 provides actuation along the long axis of robotic system 131 and is driven along guide track 153 on the opposing side of robotic system 101 to provide an equal amount of force distribution. Both wheel drive assembly 135 and 137 are synced together using encoders.

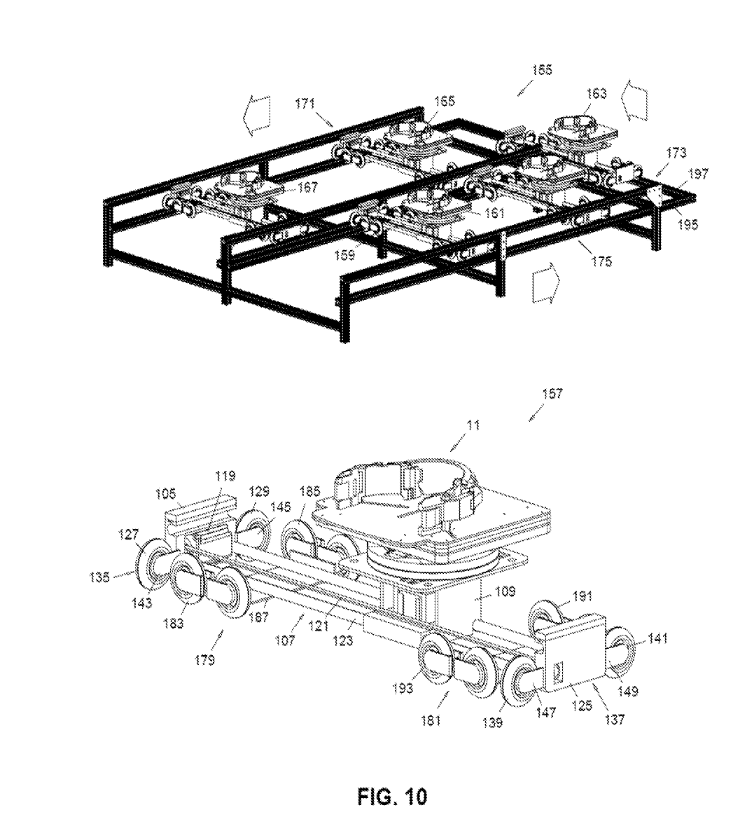

FIG. 10 elaborates on the embodiment from FIG. 9 with robotic system 155 used for retrieval and distribution of items, and its support structure 197 is shown integrated with mobile gantry units 159, 161, 163, 165, and 167. This particular embodiment highlights how multiple robotic units being carried along a core track system have the ability to make a perpendicular turn to cycle back around in the opposite direction. More specifically, first track 175 provides a forward motion lane, while second track 173 with lowering bar 195, which enables a perpendicular set of wheels from mobile gantry units to engage with track 173, further allow mobile gantry units to then drive in a perpendicular direction. Third track 171 provides the aforementioned mobile gantry units to then drive in the opposite direction effectively created a loop. This embodiment only depicts a small section which could, in other embodiments, be expanded out to a much larger configuration with perpendicular tracks accessible in different places, such as for an express track where mobile gantry units can drive ahead of others situated on a primary track to avoid congestion during item delivery or retrieval. A detailed embodiment of mobile gantry unit 157, which may be the same as the aforementioned mobile gantry units shown in robotic system 155, is shown to highlight the finer components to this core robotic assembly. Along the internal axis of gantry 107 sits the end effector drive unit 109 to which end effector 11 is coupled. Furthermore, belt drive 121 is driven by motor 119 and is situated along the internal axis of gantry 107 and drives end effector drive unit 109 along guide track 123 and is affixed to gantry end support 105 which rides along guide tracks 171, 173, and 175. Wheel drive assembly 135 which is made up of motor drives 143 and 145 and wheels 127 and 129 provides actuation along the long axis of robotic system 101 and is driven along guide track 151. An additional wheel drive assembly 137 which may be made up of motor drives 147 and 149 and wheels 139 and 141 provides actuation along the main axes of robotic system 155 and is driven on the opposing side of robotic system 155 to provide an equal amount of force distribution. Both wheel drive assembly 135 and 137 are synced together using encoders. Similarly, a second set of wheel drives 179 and 181 are situated perpendicularly at the base of mobile gantry unit 157 and is made up of wheel set 183 and 193 on one side and 185 and 191 on the opposing side. These are also synced through embedded encoders and provide motion to mobile gantry unit 157 in a perpendicular direction within the track configurations shown in robotic system 155 or variations on these configurations.

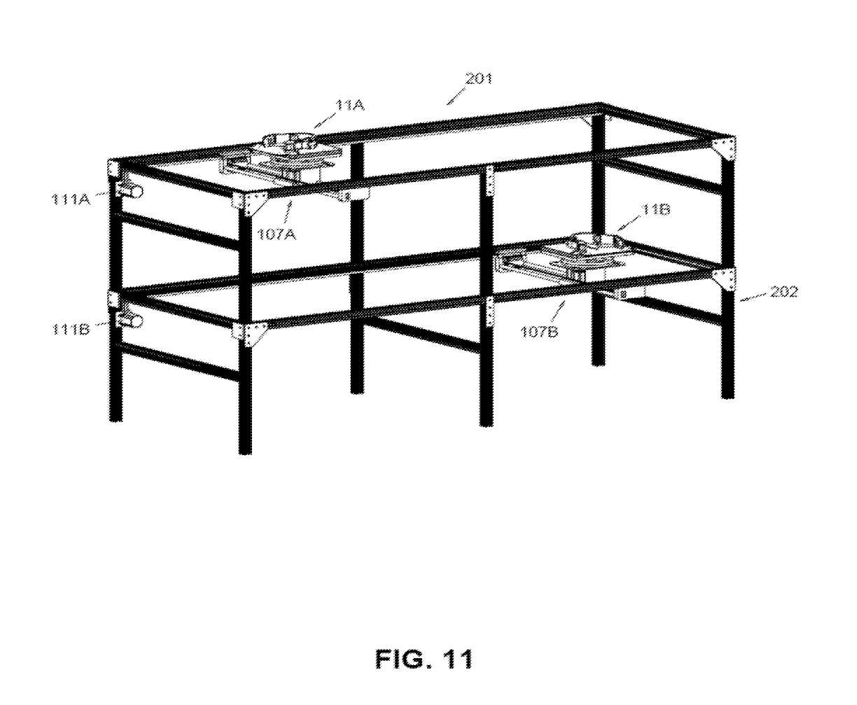

FIG. 11 is a view of one embodiment of a robotic system which integrates the embodiments shown from FIG. 8 or 9 in a stacked configuration. As shown, this may include upper section 201 with gantry 107A which carries end effector 11A and is driven by motor 111A or alternatively can be actuated with wheel drives. Lower section 202 includes gantry 107B which carries end effector 11B and is driven by motor 111B but could be actuated by wheel drives as well.

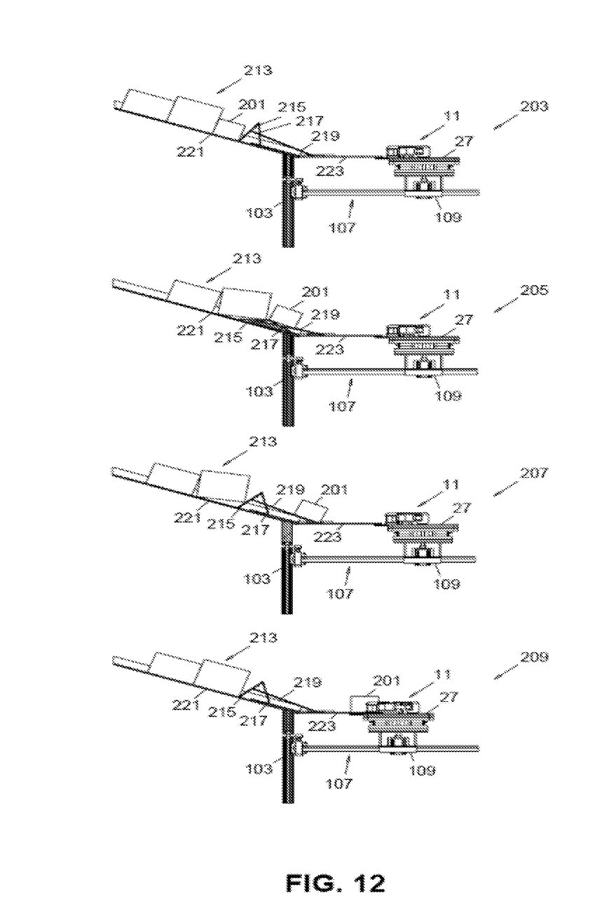

FIG. 12 illustrates a side view of a motion sequence of a robotic system 131 shown in states 203, 205, 207, and 209. State 203 shows end effector 11 at rest while packages 213 are also shown sitting at rest along gravity chute 221 with gate mechanism shown in a vertically folded state with both panels 215 and 217 situated in a vertical position while slope panel 219 of the same gate mechanism is situated in a partially tilted position away from gravity chute 221. In state 205, panels 215 and 217 are actuated through an underlying motion drive, which could be driven by a motor connected to anyone of the panels included in the gate mechanism, such that the gate mechanism is flattened along with slope panel 219. This allows a single package 201 to pass through to platform 223. State 207 shows gate mechanism made up of panels 215, 217, and 219 actuated back into a vertical position to then block packages 213 from moving forward to platform 223 allowing single 201 to be isolated. State 209 shows single package 201 being grabbed by end effector 11 as it relocated from platform 223 to carrier platform 27.

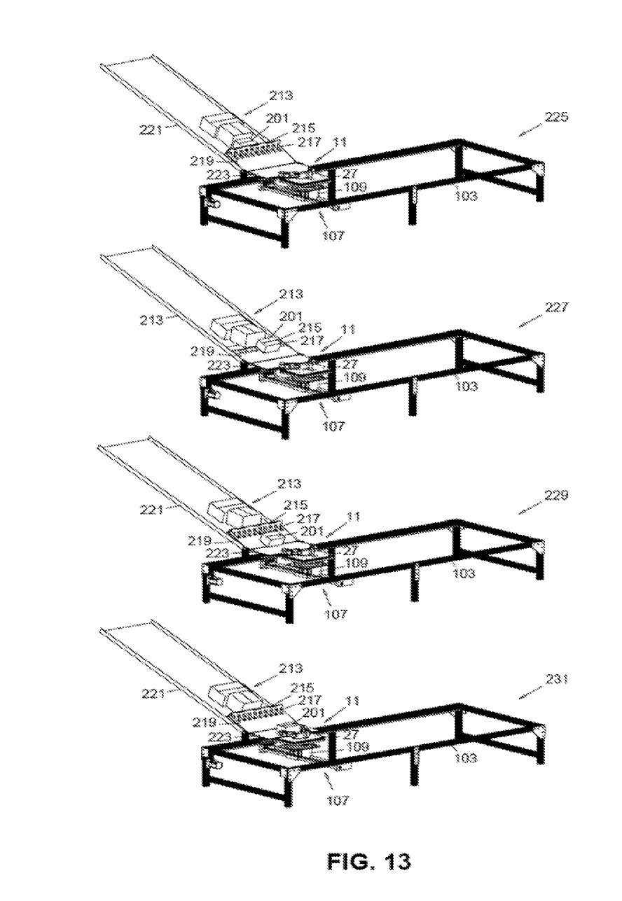

FIG. 13 is a perspective view of the motion sequence shown in FIG. 12. This perspective view is helpful to better highlight how an example gate mechanism works in that panels 219 and 217 may be mechanically interwoven such that a scissor-like configuration is achieved to better translate one panel's surface to another which prevents packages from flipping as the gate is actuated upward into a vertical position.

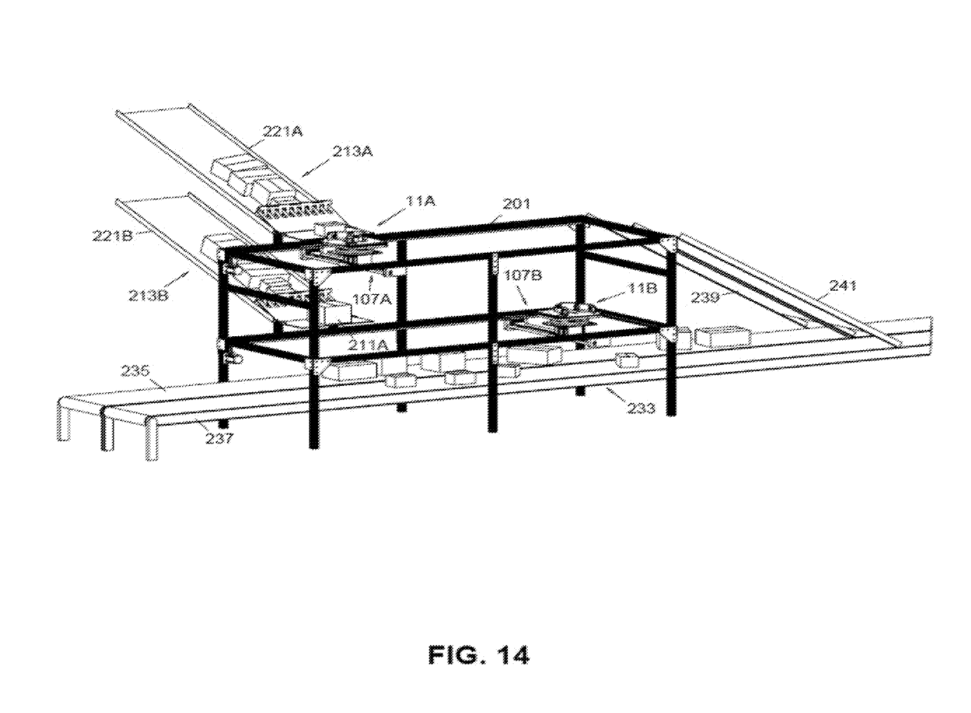

FIG. 14 is a view of the robotic system shown in FIG. 11, here having a first set of gravity chutes 221A and 221B, one for each level used for item or package retrieval in conjunction with end effectors 107A and 107B which sort and distribute them to a second set of gravity chutes 239 and 241 used for distributing package sets 213A and 213B to conveyor belts 235 and 237 situated below that then bring them to different destinations.

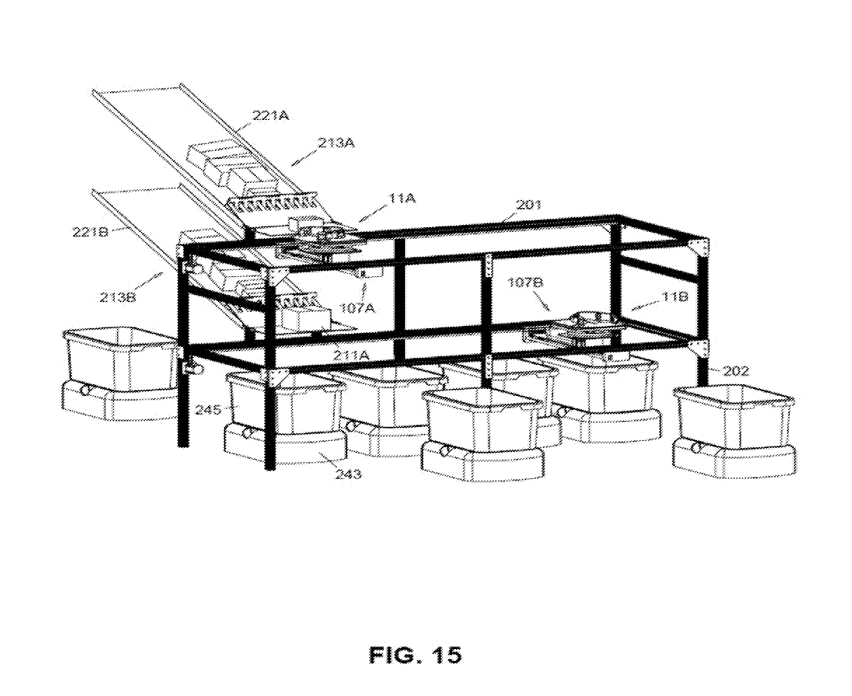

FIG. 15 is a view of the robotic system shown in FIG. 14 having a first set of gravity chutes 221A and 221B, one for each level used for item or package retrieval in conjunction with end effectors 107A and 107B which sort and distribute them to a set of mobile robots 243 carrying bins 245 which may retrieve the items ejected from end effectors 11A and 11B to carry and further sort them to different destination.

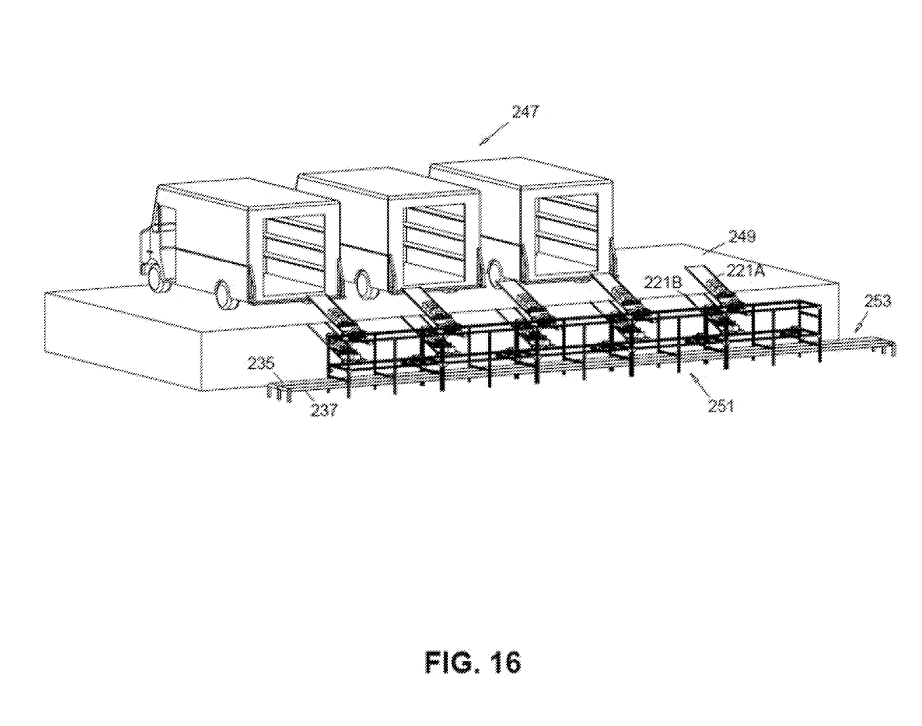

FIG. 16 is a view of the robotic system from FIG. 14 shown as a larger distribution assembly 251 retrieving packages from trucks 247 located on unloading dock 249. Similar to FIG. 14, the packages are deployed to gravity chutes 221B and 221A and then sorted to conveyor belts 235 and 237 which then bring the packages to an outgoing destination 253.

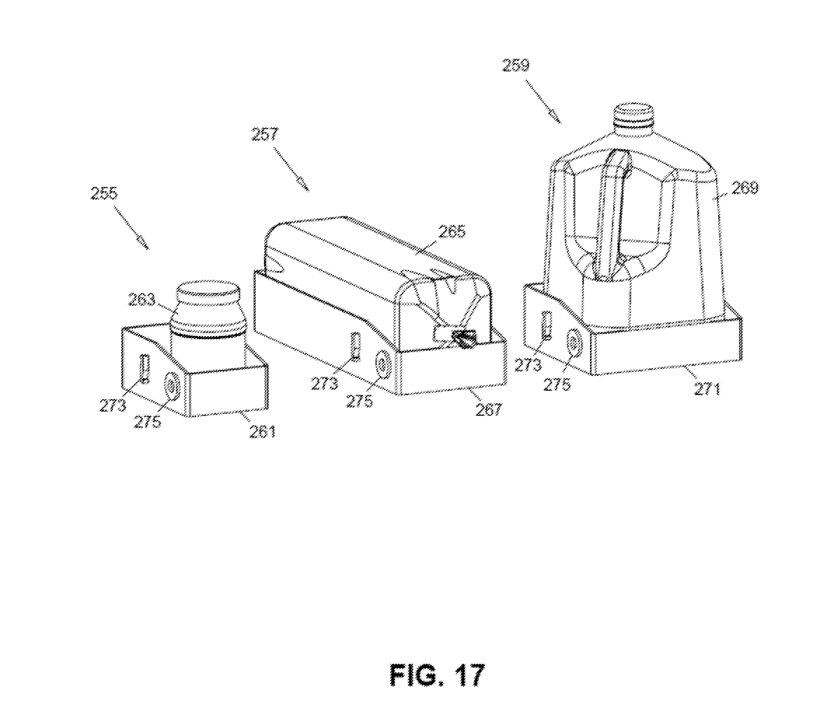

FIG. 17 is a view of three common store items, a jar of mayonnaise 263 contained within carrier cartridge 261 shown as item 255, a loaf of bread 265 contained within carrier cartridge 267 shown as item 257, and a gallon of milk 269 contained within carrier cartridge 271 shown as item 259. Each separate carrier cartridges includes an embedded RFID sensor, a grabbing interface 275 on each side of the cartridge for the gripper to engage with, and a compression lock 273. Because grabbing a large variety of items with different sizes, shapes, and weights is a complex task with a high failure rate, even with the most robust computer vision system and gripping mechanics integrated into a system, variability is still a challenging problem to tackle. Therefore, the solutions presented helps to standardize the form of every item in such a way that a simple gripper can more consistently retrieve and distribute items in a store with a very low failure rate.

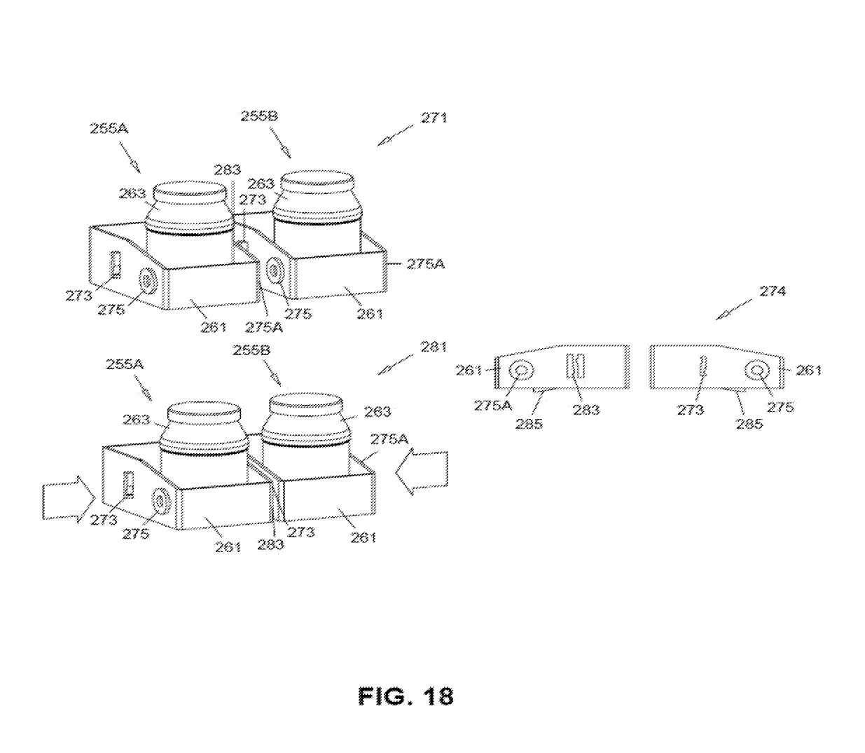

FIG. 18 is a diagram of carrier cartridge 261 and jar of mayonnaise 263 shown as two items 255A and 255B detached from each other in a first state 271. A second state 281 shows items 255A and 255B being compressed together in such a way they will link together. This occurs as a gripper engages with grabbing interfaces 275 and 275A, which are more clearly shown at the front of both sides of carrier cartridge 261 in diagram 274. The compression locks 283 and 273 are also shown in diagram 274 to highlight how one geometry mates with the other. Connecting items 255A and 255B, or any other items in multiple block is advantageous since it allows the gripper to grab multiple item at once to save time as it is retrieving and distributing those items locally to a gantry carrier which will be highlighted further in a later figure.

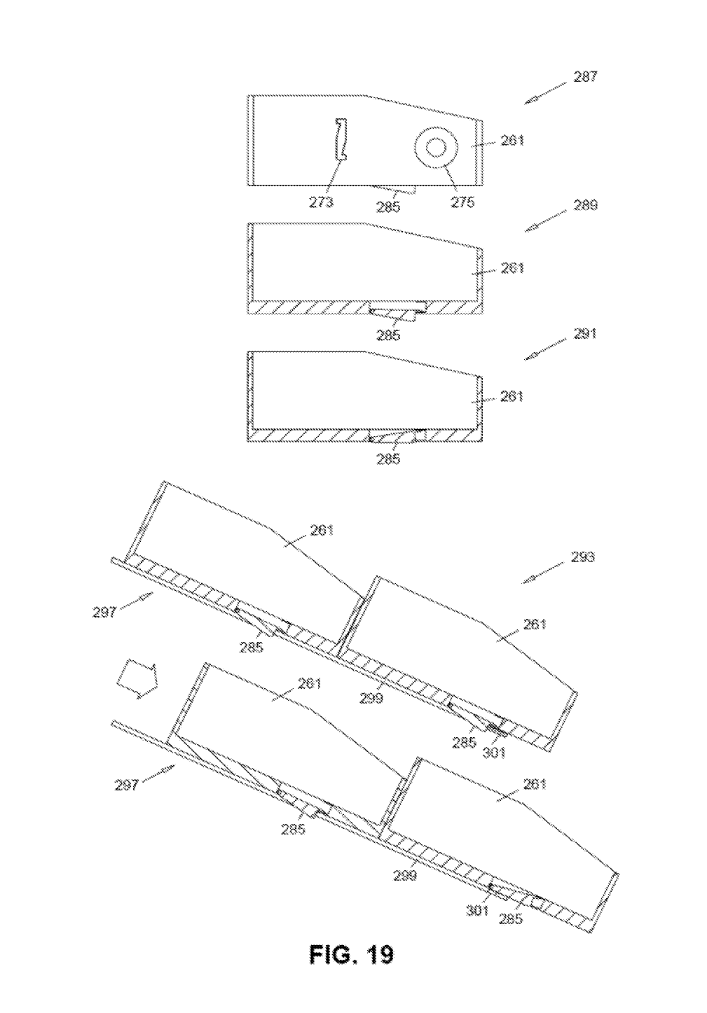

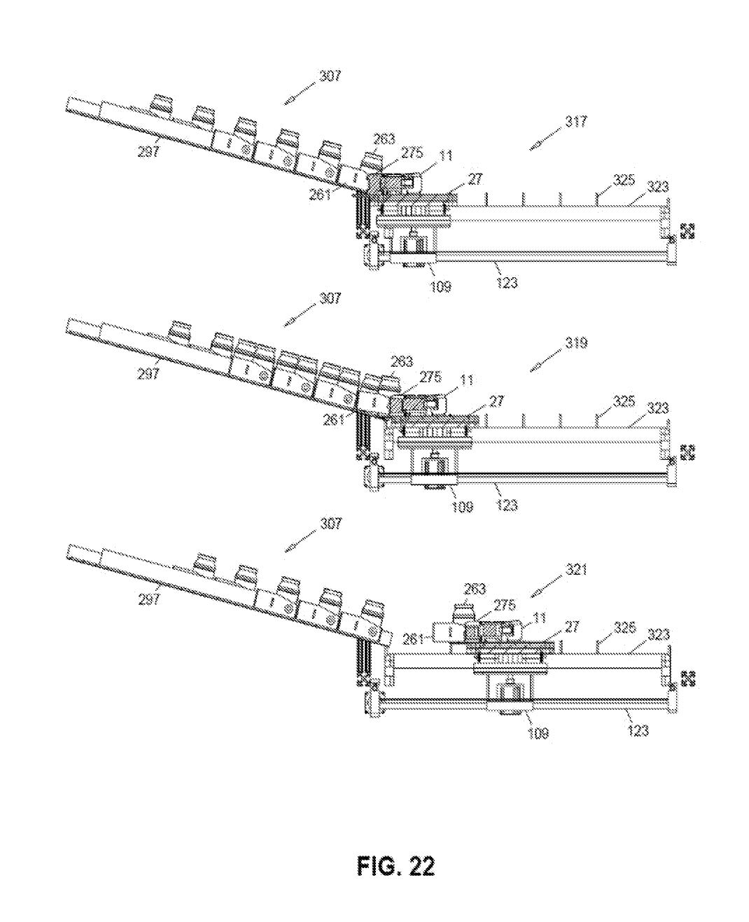

FIG. 19 is a sectional view diagram of carrier cartridge 261 and its underlying latch mechanism 285. Side view 287 shows the same external features highlighted along the side of carrier cartridge 261 in FIG. 18, while sectional views 289 and 291 show how latch mechanism 285 can sit in an open state and then a closed state to provide either a stop along its bottom surface, or slat continuous surface. Sectional view 293 shows how latch mechanism 285 can provide a stop against section 301 of gravity chute 297 to prevent it from sliding forward. Latch mechanism 285 fits inside channel 299 and when it is closed, carrier cartridge 261 is able to slide past section 301 on gravity chute 297. This in turn allows carrier cartridges that sit behind the first carrier cartridge at the front of gravity chute 297, which is being grabbed and retrieved by the end effector, to slide forward down the chute until the next front of the line carrier cartridge latch provides a stop to prevent the remaining group of cartridges from sliding forward which is further illustrated in FIG. 22.

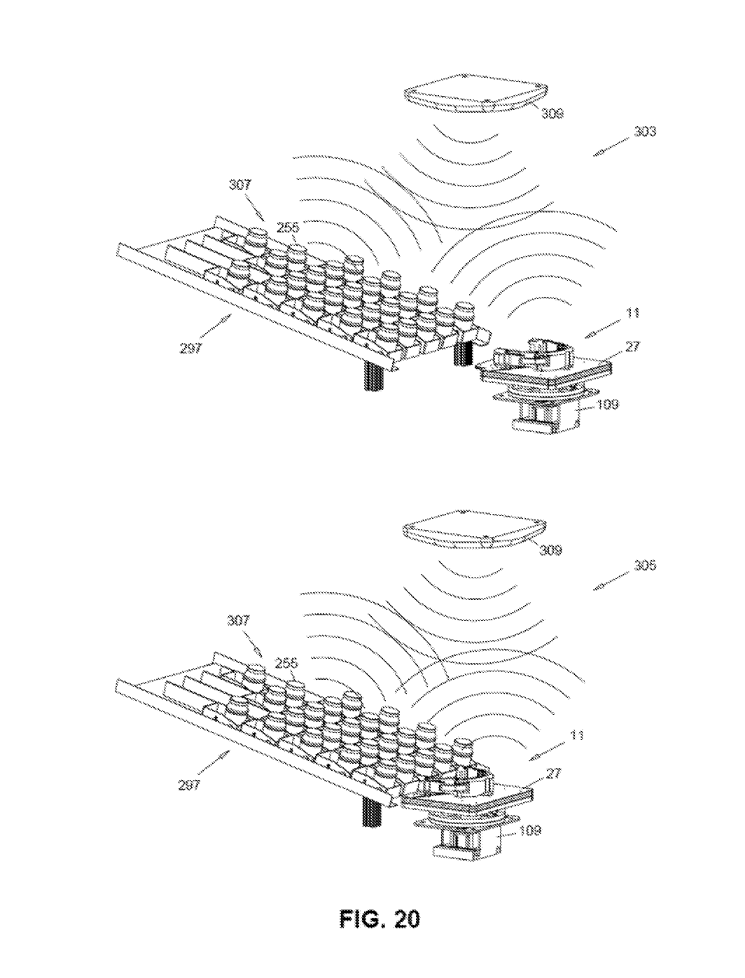

FIG. 20 is a diagram of end effector 11 shown in state 303 and 305 grabbing mayonnaise item 255 in a cluster of two from a group of mayonnaise jars 307 located on gravity chute 297 as an overhead RFID antenna 309 reads the RFID sensors embedded within the carrier platform 27 of end effector 11 each of the carrier cartridges below to generated a map of where all items and end effectors are located with the entire robotics system.

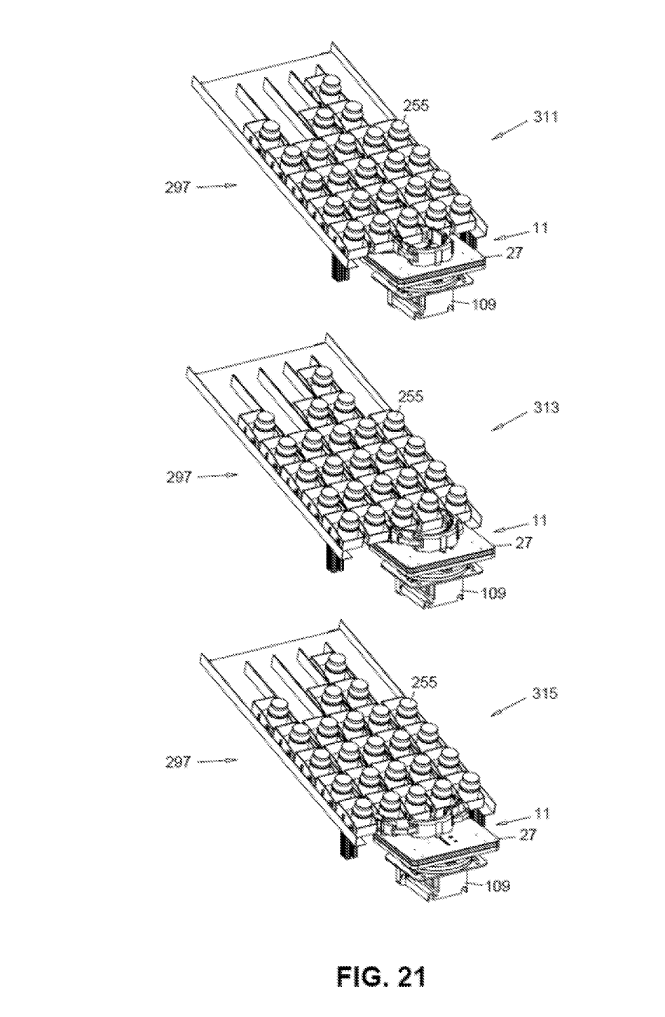

FIG. 21 is a diagram of end effector 11 shown in a first state 311 grabbing a single mayonnaise item 255, which consists of a jar of mayonnaise contained with a carrier cartridge, from a group of mayonnaise items situated on gravity chute 297. In a second state 313 two of said mayonnaise item 255 are shown being grabbed together by end effector 11. In a third state 315, three of said mayonnaise item 255 are shown being grabbed together by end effector 11.

FIG. 22 is a sectional view diagram of end effector 11 shown grabbing and relocating mayonnaise jar 263 and its carrier cartridge 261 from gravity chute 297 in such a way that it rotates from an angled position to a flat position on carrier platform 27. This detail highlights the need for grabbing interface 275 located on both sides of carrier cartridge 261 to be either fully or partially cylindrical in shape so that when end effector 11 grabs carrier cartridge 261, it can rotate to a flat position without slipping away from the gripper. The gripper itself also required a fully or partially cylindrical shape to engage with grabbing interface 275. Once mayonnaise jar 263 is grabbed from its carrier cartridge 261 shown between state 317 and 319, it is then shown pulled back in state 231 so that it may then deploy items to local gantry carrier 323 between adjustable partitions 325.

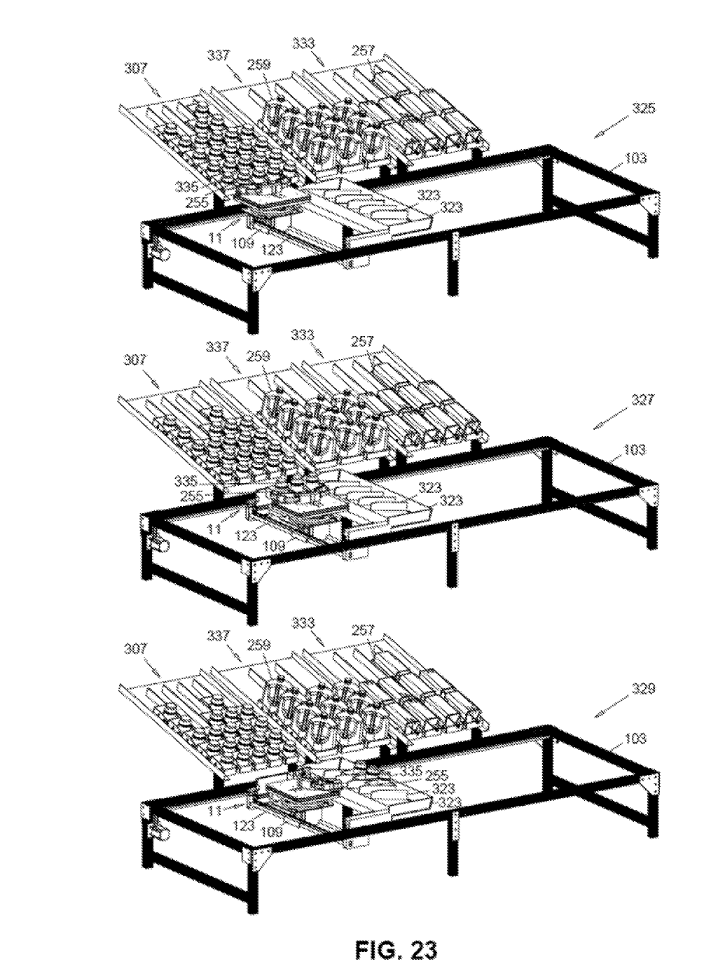

In accordance with the example embodiment shown in FIG. 23, robotic system 101, which was first shown in FIG. 8, is expanded in function with gravity chutes 307, 337, and 333, which each contain a separate group of items that are each held within individual carrier cartridges. A first state 325 shows end effector 11 grabbing three units 355 of mayonnaise item 255 from gravity chute 307. In a second state 327, the three units 335 of mayonnaise item 255 are then pulled back through end effector drive unit 109 along gantry guide track 123. In a third state 329, end effector 11 is shown having rotated and deployed the three units 335 of mayonnaise item 255 to gantry carrier 323 in between partitions 325. The partitions can be used to separate each of the carrier cartridges if they have been initially linked together from their connecting locks as discussed in earlier figures.

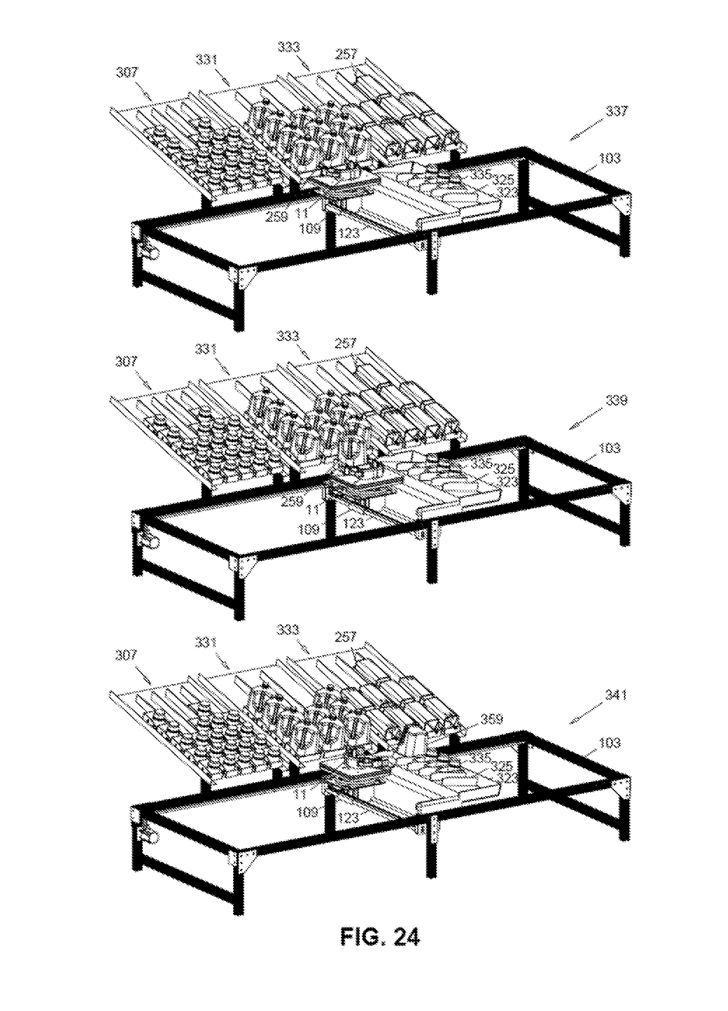

In accordance with the example embodiment shown in FIG. 24, robotic system 101, is shown with a configuration consistent with that shown in FIG. 23 with chutes 307, 337, and 333, which each may contain a separate group of items that are each held within individual carrier cartridges. A first state 337 shows end effector 11 grabbing milk gallon item 259 from gravity chute 331. In a second state 339, milk gallon item 259 is then pulled back through end effector drive unit 109 along gantry guide track 123. In a third state 341, end effector 11 is shown having rotated and deployed milk gallon item 259 to gantry carrier 323 in between partitions 325. It should be understood that a back opening on each carrier cartridge could also allow the item to be deployed into gantry carrier 323 such that the carrier cartridge itself can then be separately deployed down a chute for empty carrier cartridge just below the gravity chute where the item are initially being pulled from. This way the item can move to the next phase of its journey so that when it reaches the customer it may not need to be contained with the carrier cartridge.

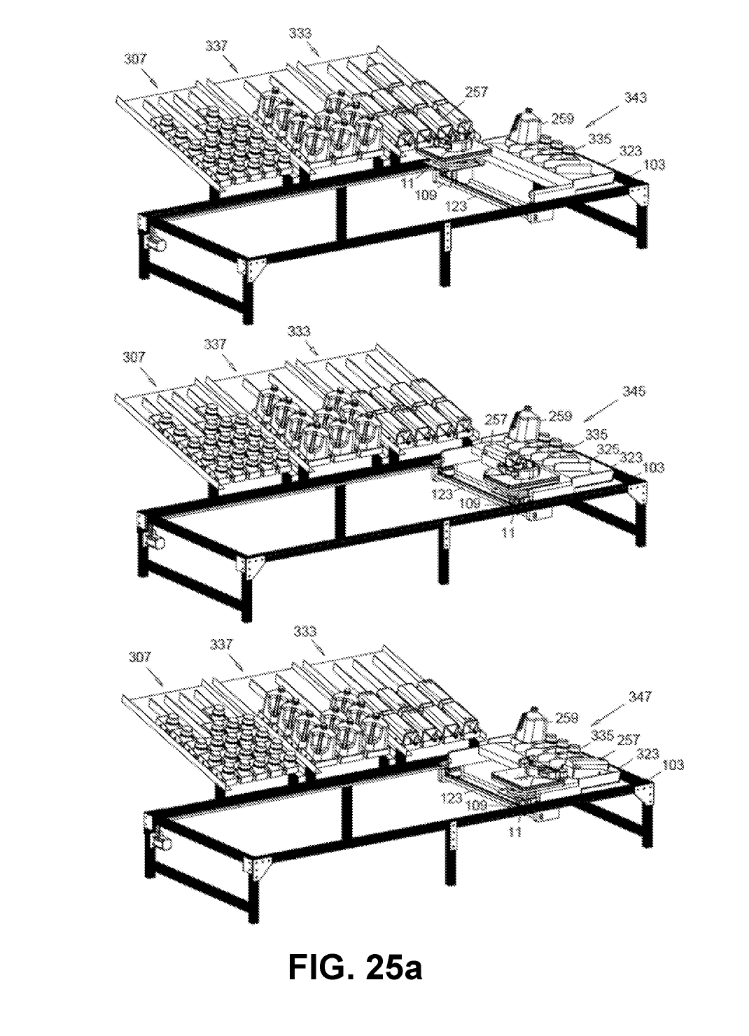

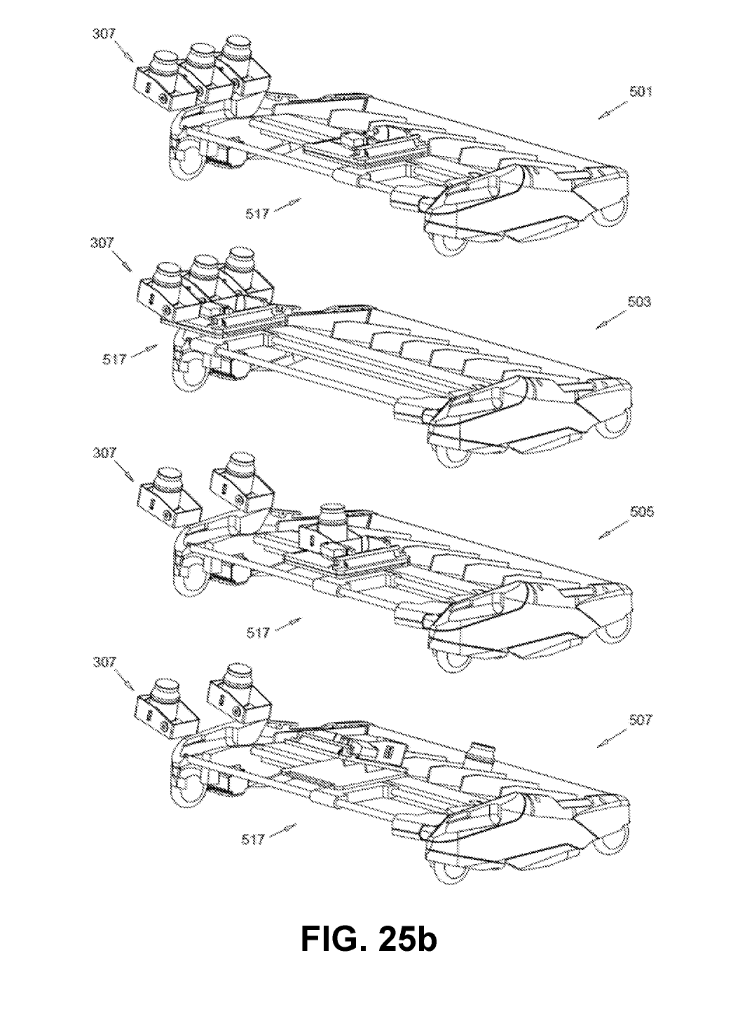

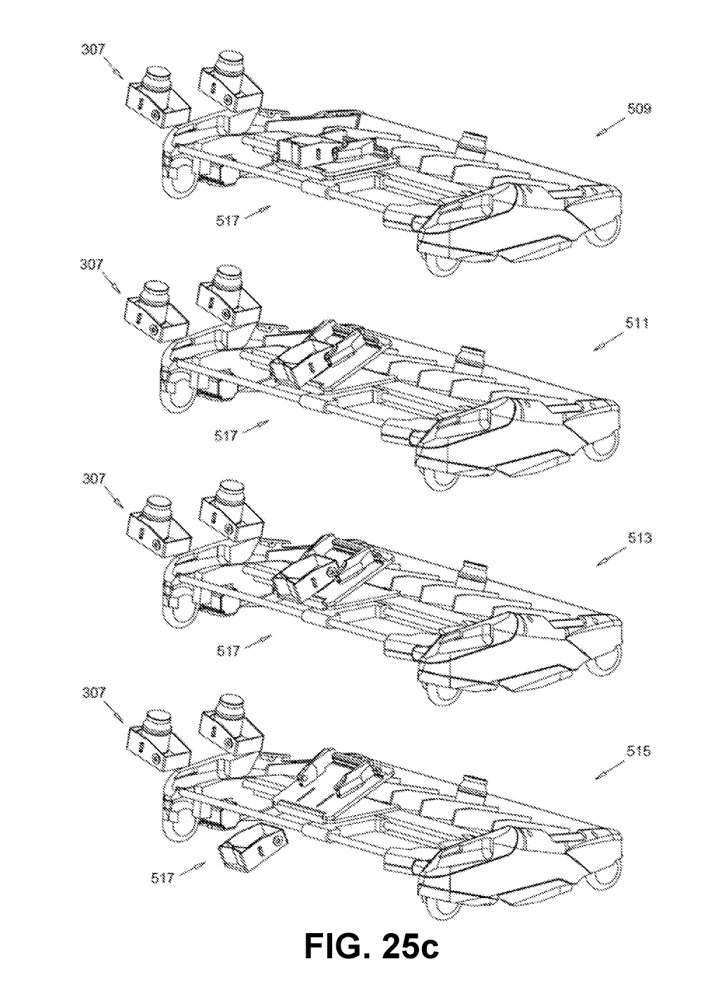

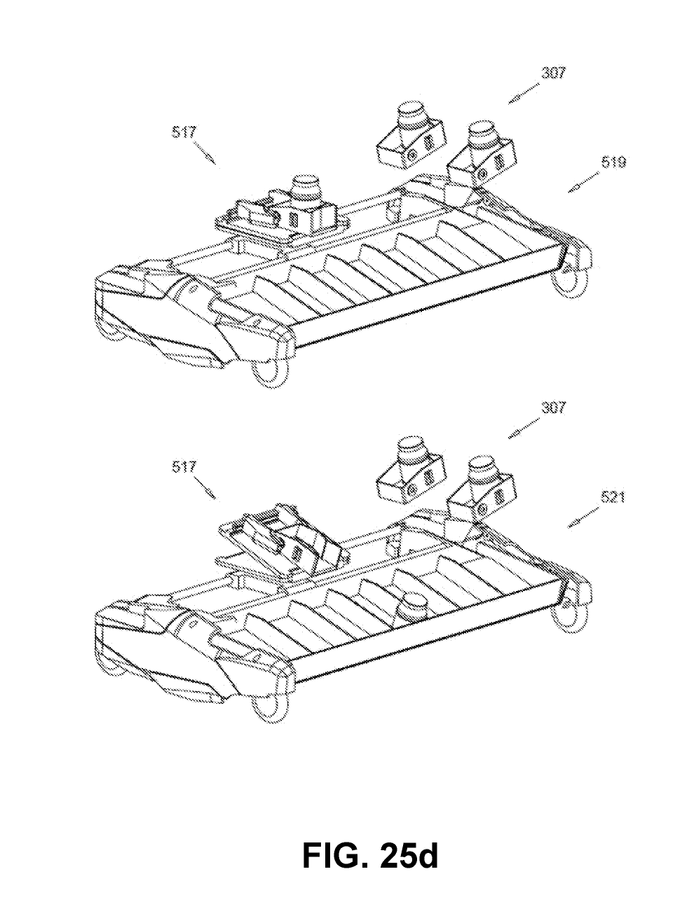

In accordance with the example embodiment shown in FIG. 25a, robotic system 101, is shown with the same configuration as in FIGS. 23 and 24 with chutes 307, 337, and 333, which each contain a separate group of items that are each held within individual carrier cartridges. A first state 343 shows end effector 11 grabbing loaf of bread item 257 from gravity chute 333. In a second state 345, loaf of bread 257 is then pulled back through end effector drive unit 109 along gantry guide track 123. In a third state 347, end effector 11 is shown having rotated and deployed loaf of bread 257 to gantry carrier 323 in between partitions 325.

FIG. 25b is a sequence diagram of a robotic vehicle with an end effector that includes a hybrid gripper and a tilt plate shown in operation retrieving and distributing jars from a gravity chute to a local gantry carrier platform. This sequence includes positions 501, 503, 505, and 507. Position 501 shows the jars 307 off to the side as they would sit on a gravity chute with their latches deployed to hold them in place at the edge of the gravity chute. Additionally, hybrid gripper tilt plate carrier 517 is shown at rest in the center of the robotic vehicle situated on its respective guide track. Position 503 shows gripper tilt plate carrier 517 grabbing one of the jars situated in an individual carrier cartridge, while position 505 shows the gripper tilt plate carrier 517 then moving back towards the center of the robotic vehicle. The final position 507 shows gripper tilt plate carrier then rotating 90 degrees so that it can then actuate its tilt plate upward on an angle which ultimately forces the jar to be released for its carrier cartridge so that it may land in the robotic vehicle's local storage platform. A back side of the jar's carrier cartridge may include a back door that is opened once the tilt plate is actuated upward, or through some other mechanical actuation means. The carrier cartridge may also include an RFID tag which is scanned once it is first deployed to gripper tilt plate carrier plate 517.

FIG. 25c is a continuation of FIG. 25b showing a sequence diagram of a robotic vehicle with an end effector that shows hybrid gripper tilt plate carrier 517 shown in operation retrieving and distributing jars from a gravity chute to a local gantry carrier platform. In this sequence, which includes positions 509, 511, 513, and 515, gripper tilt plate carrier 517 is shown releasing the same carrier cartridge that had just released a jar onto the robot's local storage platform. In this case, position 509 shows gripper tilt plate carrier rotating 180 degrees back from the final position 507 from FIG. 25b, while position 511 then shows gripper tilt plate carrier 517 then being actuated upward on an angle. Position 513 then shows the gripper fingers of gripper tilt plate carrier opening so as to release the carrier cartridge down a secondary chute that will sit below the robotic vehicle. The final figure shows the carrier cartridge being fully released and forced through gravity to its secondary gravity chute. From there, the gravity chute may guide the carrier cartridge to a conveyor belt or another robotic vehicle so that it may be brought back to the front of the entire distribution system as it is similarly shown in previous and later figures.

FIG. 25d is a view of the front side of the sequence diagram from FIG. 25b showing a robotic vehicle with an end effector that includes gripper tilt plate carrier 517 shown in operation retrieving and distributing jars from a gravity chute to a local gantry carrier platform through a dynamic door opening on the back of a carrier cartridge. In position 519, the gripper tilt plate carrier 517 is shown at rest in the center of the robotic vehicle where it may use basic sensors or computer vision to detect and align itself with the optimal partition segment so that the jar can then be properly released to the robotic vehicle's local storage platform. Position 521 further shows this function where doors on the back side of the jar's carrier cartridge are opened so that the jar can be released as gripper tilt plate carrier is tilted upward on an angle. The doors on the back side may also be actuated from a built-in keying mechanism that engages with the carrier cartridge when the tilt plate is angled upward. It is important to note that while the carrier cartridge can use standard mechanical components such as pins and fasteners to hold all of its parts together, living hinges may also be used so that each carrier cartridge may be manufactured more inexpensively. Carrier cartridges may also be eliminated entirely from the system and the robotic vehicles could still operate using the same basic features including the gripper tilt plate carrier to retrieve items that are sitting on shelves so that they may be deployed by the robot's manipulator to the robot's local storage platform. In place of the gripper tilt plate, a suction cup manipulator may also be used grab items from shelves so that they may then be released to the robot's local storage platform.

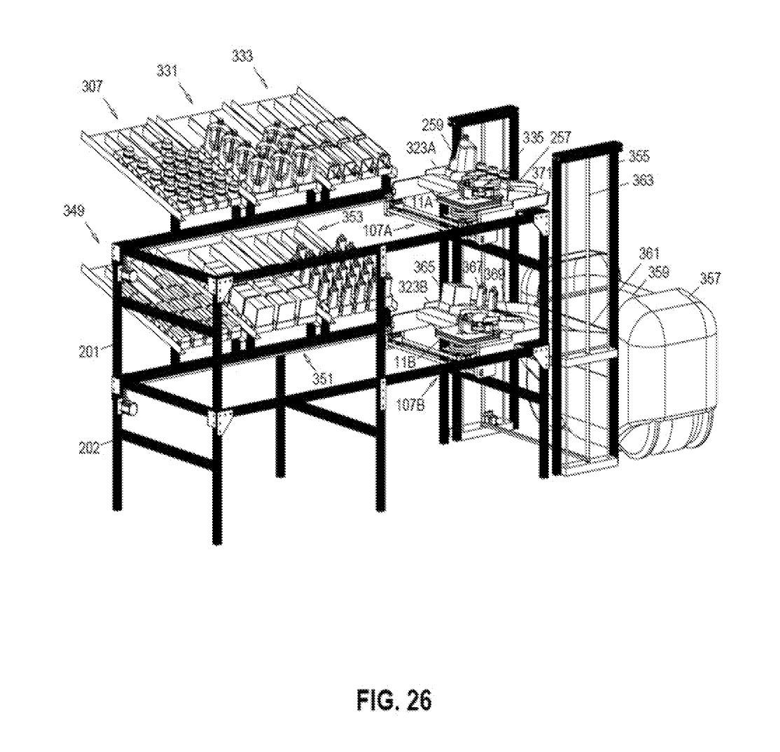

FIG. 26 is a view of a robotic system similar to FIGS. 23, 24, and 25, but shown in a stacked configuration with elevator platform 355 situated at the end of the robotic system shown to lower items into cart 357. A second set of different items is shown on three gravity chutes 349, 351, and 353 which is situated on the lower level. It should be noted that while these robotic system embodiments are sometimes shown with a belt drive configuration to move the mobile gantry unit along the system's long axis, these same configurations may use wheel drive instead, especially when long travel or perpendicular travel is required.

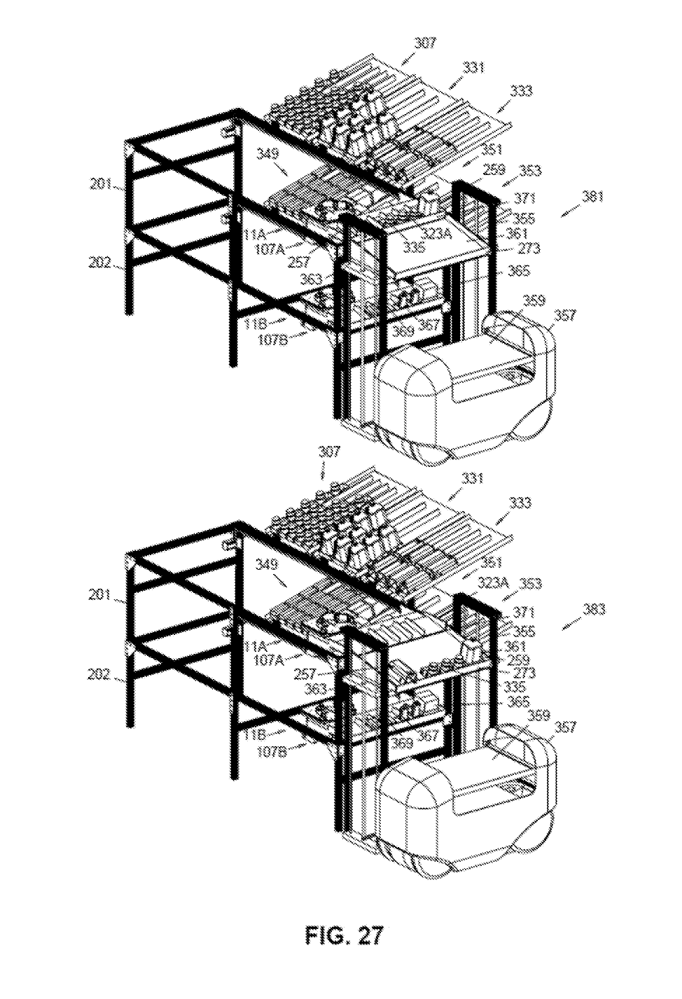

FIG. 27 is a diagram of the robotic system from FIG. 26 shown distributing items in carrier cartridges from gantry carrier 323 to elevator carrier platform 361. The items may be deployed from a gate 371 which is lowered allowing the slope of gantry carrier 323 to provide enough gravity force to push the item forward onto elevator carrier platform 361. The force required to push the items from one platform to another does not need to be limited to just gravity and can be actuated through motors and other mechanical mechanisms.

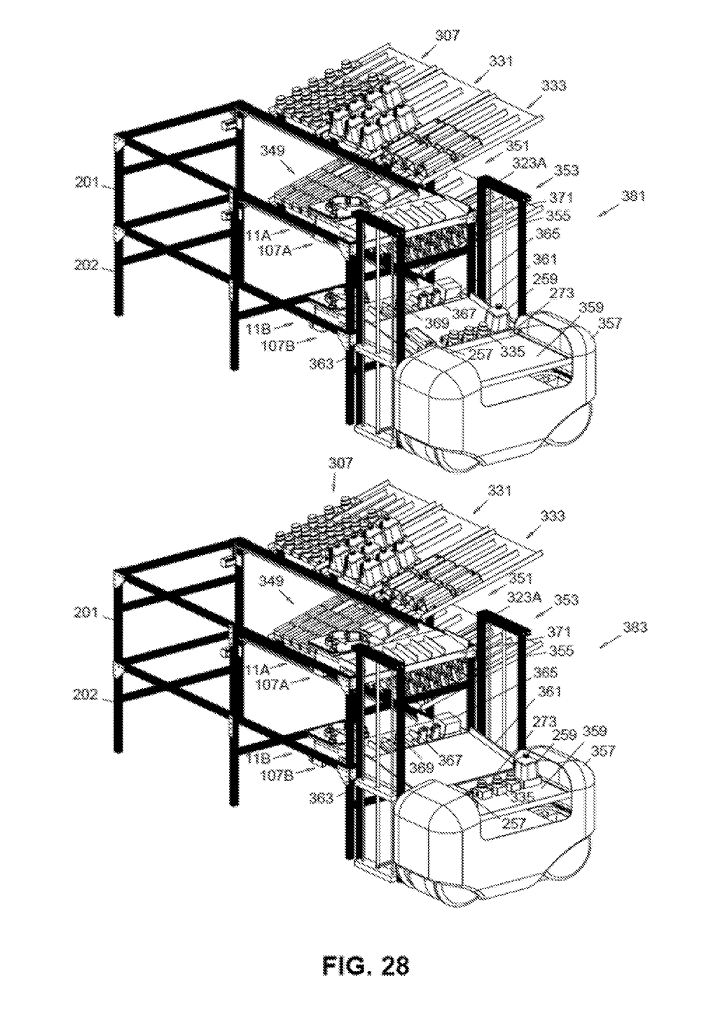

FIG. 28 is a diagram of the robotic system from FIG. 27 shown distributing items in carrier cartridges from elevator carrier platform 361 to cart carrier platform 359 located inside cart 357. The items are deployed from a gate 273, which can be seen lowered between first state 381 and second state 383, allowing the slope of gantry carrier 323 to provide enough gravity force to push the item forward onto cart carrier platform 359. Similar to FIG. 27, the force required to push the items from one platform to another does not need to be limited to just gravity, and can be actuated through motors and other mechanical, electrical, and/or magnetic mechanisms.

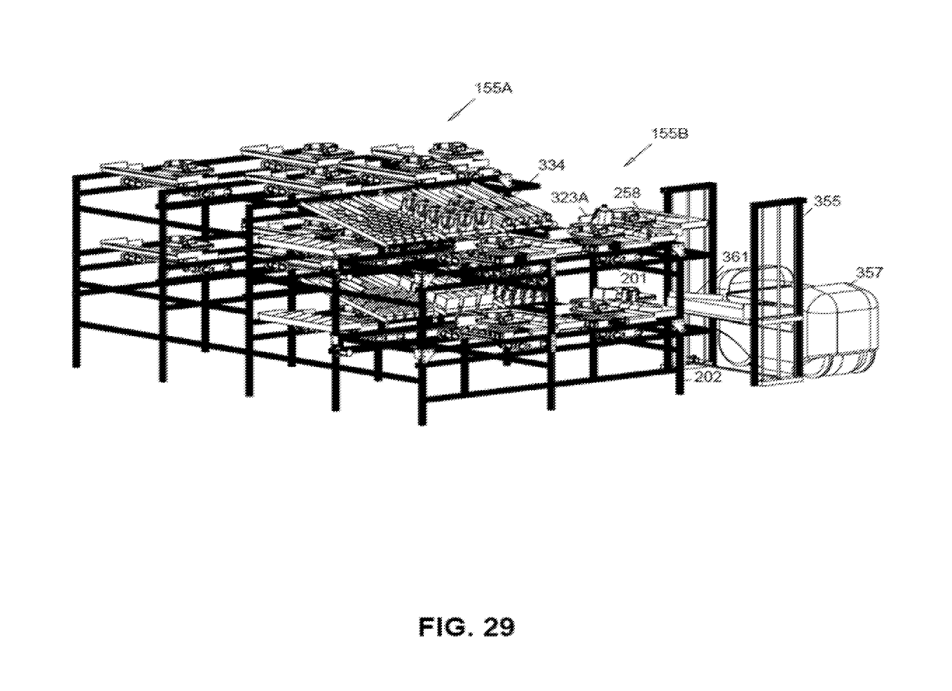

FIG. 29 is a view of a robotic system which combines the embodiment shown in FIG. 10 with the embodiment shown in FIG. 26 to illustrate a fully automated system where items are distributed from one set of mobile gantry units 155A, which may be aligned with the top portion of gravity chutes 334 and cycle back to the front of the system in a loop, and then from there the items are retrieved and distributed to gantry carrier 323A, which are shown as items 258, from a second set of mobile gantry units 155B that are carried within lower structure 202 and upper structure 201 which are also configured to cycle back to the front of the system in a loop. The operation of the system includes distributing items 258 to elevator 355 and then to cart 357 which is then either autonomously or manually brought to the consumer.

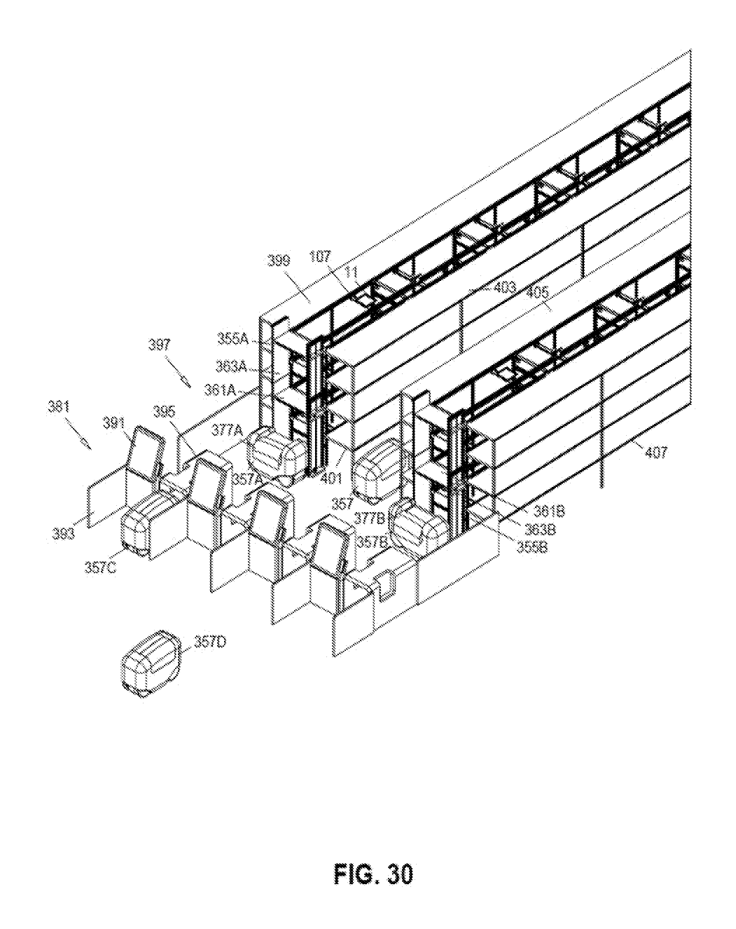

FIG. 30 is a partial view of the robotic system shown in FIG. 29 configured as a fully automated store with multiple layers having an extended structure for greater travel. Kiosk area 381 for customer item selection is also shown in FIG. 30 at the front of shelves 399, 403, 405, and 407. In a typical configuration, cart 357 waits at the front of a series of carts which are lined up within a space located between shelves 403 and 405 which are waiting to be fulfilled with customer items from the robotic system in the item deployment area 397. Carts 357A and 357B are shown at the base of elevators 355A and 355B respectively as they await an order fulfillment to be autonomously deployed by any one of many mobile gantry units, such as gantry 107 and end effector 11 located internally and tangent to the elongated storage shelves which contain gravity chutes along shelf 401 shown at the lower level of shelving unit 403, or any other shelf within the system. Once a cart is fulfilled with a new order taken from a customer's item selection input which is processed through kiosk 391, or any other kiosk that is available, their cart is then autonomously brought to them through the cart deployment section 393 where cart 357C is located. Before the cart is deployed to the customer though, a final verification scan of the items is made through a cart check system 395 which uses different methods for verifying that the items are correct, such as through computer vision and an additional RFID antenna. From that point, the customer can either manually push the cart to their final destination, such as a vehicle in a parking lot, or have the cart operate autonomously to follow the customer to their final destination. Once they have taken all their items out of the cart, the cart can then autonomously travel back to a cart retrieval area which is located on the other side of the fully automated store system where they can enter the front of the cart line to await its next fulfillment order.

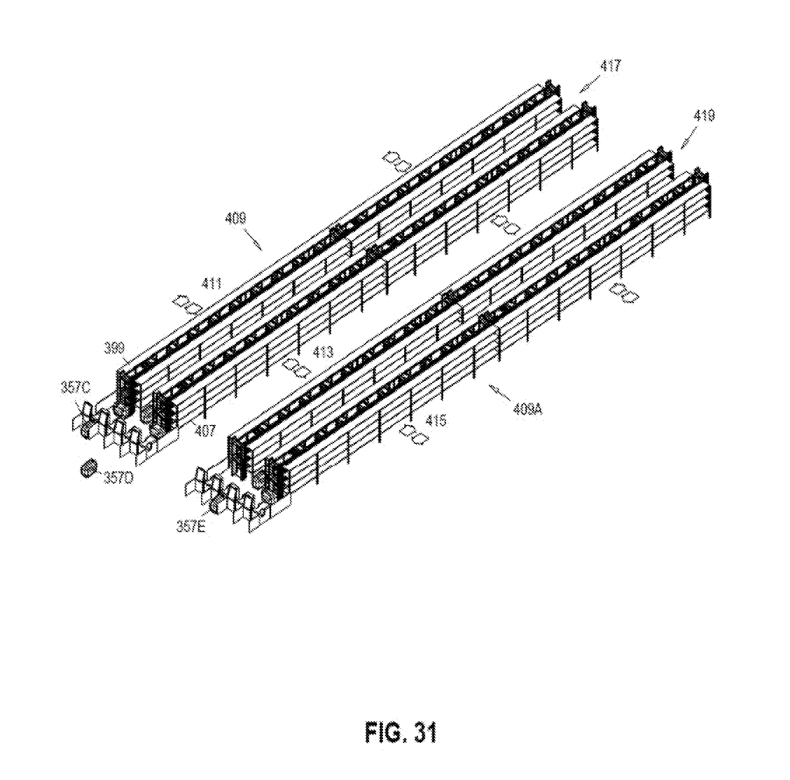

FIG. 31 is a view of the robotic system shown in FIG. 30 configured with two major blocks 409 and 409A as a fully automated store with multiple layers, an extended structure for greater travel, a kiosk area for customer item selection, and a cart deployment area. It should be understood that this fully automated store also allows the system to be used as a standard store configuration whereby path 411, 413, and 415 provide walking paths so that consumers can browse shelves as they would in a traditional store. This is advantageous because it provides an express option for consumers who know what they want, and a more hands-on traditional option for customers who would prefer to browse for their items. Shelf 407, for example, is facing towards path 413, and would have items on shelves with gravity chutes configured on the internal side, while also having a configuration facing outward so that consumers can access these items from path 413, which is comparable to a standard store isle walkway. These items would also be held in carrier cartridges so that the fully automated store system could still deploy the items for automated retrieval and for direct consumer access. And while the carrier cartridges present a viable option for lower failure rate and high precision automated retrieval and delivery, a similar configuration could still be used without carrier cartridges as well. Items in this case would be grabbed in a more conventional way but would still be distributed through mobile robots guided in a layered structure. Item entry points 417 and 419 are provided at the opposite end of the kiosk area to allow items to be deployed within the system through the internal mobile gantry units, which in turn will deploy items to their assigned storage locations along internal shelves with gravity chutes.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent component names other than those provided herein can be applied to the various partitions.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known,” “common” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to,” and other like phrases in some instances shall not be read to mean that the narrower case is intended or required in instances where such broadening phrases may be absent.

What is claimed is:

1. A robotic system for retrieving and distributing material comprising:
one or more autonomous mobile vehicles, each autonomous mobile vehicle having a manipulator to retrieve one or more items, a local storage platform for carrying one or more items, and electronics to provide processing, control of mobility, and wireless communication such that each autonomous mobile vehicle can communicate with a central control system, said manipulator having a guide portion spanning from a first end to a second end of said autonomous mobile vehicle such that said manipulator with carrier portion can travel from said first end to said second end.

2. The robotic system of claim 1, wherein said manipulator can rotate 360 degrees.

3. The robotic system of claim 1, wherein said manipulator includes a gripper.

4. The robotic system of claim 3, wherein said gripper includes two primary portions that can travel inward to grab an item.

5. The robotic system of claim 3, wherein said gripper includes two primary portions for grabbing an item made up of a four bar linkage such that a portion of the four bar linkage can eject an item.

6. The robotic system of claim 1, wherein said manipulator includes a tilt plate.

7. The robotic system of claim 1, wherein said manipulator includes a gripper and a tilt plate.

8. The robotic system of claim 1, wherein said manipulator includes a carrier portion that can carry an item.

9. The robotic system of claim 1, wherein said manipulator is configured such that a gripper portion sits above a carrier portion so as to allow an item to be held by said gripper portion while it is carried on said carrier portion.

10. The robotic system of claim 1, wherein said manipulator includes a suction cup component for grabbing an item.

11. The robotic system of claim 1, wherein said local storage platform is angled such that items can be ejected through gravity.

12. The robotic system of claim 1, wherein said local storage platform has a door portion that can release one or more items to a second location.

13. The robotic system of claim 1, wherein an elevator is included to raise and lower said autonomous mobile vehicle.

14. The robotic system of claim 1, wherein an elevator is included to raise and lower items deployed to it by said autonomous mobile vehicle.

15. A robotic system for retrieving and distributing material comprising:
one or more autonomous mobile vehicles, each autonomous mobile vehicle having a manipulator to retrieve one or more items, said manipulator having an interface that engages with an item carrier cartridge interface such that said manipulator can relocate said carrier cartridge to a location locally on said autonomous mobile vehicle.

16. The robotic system of claim 15, wherein said manipulator is a gripper.

17. The robotic system of claim 16, wherein said gripper includes two primary portions that can travel inward to grab an item.

18. The robotic system of claim 15, wherein said manipulator is a suction cup.

19. The robotic system of claim 15, wherein said manipulator includes a tilt plate.

20. The robotic system of claim 15, wherein said manipulator includes a gripper and a tilt plate.

21. The robotic system of claim 15, wherein said carrier cartridge interface can mechanically actuate other portions of the carrier cartridge when said manipulator applies a force.

22. The robotic system of claim 15, wherein said carrier cartridge interface can mechanically actuate other portions of the carrier cartridge when said manipulator applies a force.

23. The robotic system of claim 15, wherein said manipulator includes a carrier portion that can carry an item.

24. The robotic system of claim 15, wherein said manipulator is configured such that a gripper portion sits above a carrier portion so as to allow an item to be held by said gripper portion while it is carried on said carrier portion.

25. The robotic system of claim 15, wherein said local storage platform is angled such that items can be ejected through gravity.

26. The robotic system of claim 15, wherein said local storage platform has a door portion that can release one or more items to a second location.

27. The robotic system of claim 15, wherein an elevator is included to raise and lower said autonomous mobile vehicle.

28. The robotics system of claim 15, wherein an elevator is included to raise and lower items deployed to it by said autonomous mobile vehicle.

29. A robotic system for retrieving and distributing material comprising:
one or more carrier cartridge units for carrying one or more items, each carrier cartridge unit having a universal interface for a manipulator to engage with, and a release mechanism to eject one or more items.

30. The robotic system of claim 29, wherein said carrier cartridge release mechanism is made up of a door that can open and close.

31. The robotic system of claim 30, wherein said door has one or more panels.

32. The robotic system of claim 29, wherein said door can be actuated from a force applied by said manipulator.

33. The robotic system of claim 29, wherein said door can be actuated from a keying mechanism.

34. The robotic system of claim 29, wherein said carrier cartridge contains a radio-frequency identification (RFID) tag that can be detected when said manipulator engages with said carrier cartridge.

35. The robotic system of claim 29, wherein said carrier cartridge interface can mechanically actuate other portions of said carrier cartridge when said manipulator applies a force.

36. The robotic system of claim 29, wherein said carrier cartridge has a latch that is actuated to act as a stop within a shelf guide track such that it can be retracted when said manipulator provides a mechanical force.

37. The robotic system of claim 29, wherein said carrier cartridge has a latch that is actuated to act as a stop within a shelf guide track such that it can be retracted when said manipulator provides a mechanical force.
